(19) United States
(12) Patent Application Publication
(10) Pub. No.: US 2015/0240043 A1
(43) Pub. Date: Aug. 27, 2015

(54) POLYETHYLENE-BASED RESIN FOAMED PARTICLES, POLYETHYLENE-BASED RESIN IN-MOLD-FOAM-MOLDED BODY, AND METHOD FOR PRODUCING POLYETHYLENE-BASED RESIN FOAMED PARTICLES

(71) Applicant: KANEKA CORPORATION, Osaka-shi (JP)

(72) Inventors: Toru Yoshida, Settsu-shi (JP); Akihiro Itoi, Settsu-shi (JP)

(73) Assignee: KANEKA CORPORATION, Osaka-shi (JP)

(21) Appl. No.: 14/427,529

(22) PCT Filed: Sep. 11, 2013
(86) PCT No.: PCT/JP2013/074533

§ 371 Date: Mar. 11, 2015

(30) Foreign Application Priority Data
Sep. 12, 2012 (JP) 2012-200921

(51) Int. Cl. C08J 9/00

(52) U.S. Cl. CPC C08J 9/0066; C08J 9/0052; C08J 9/0038

(57) ABSTRACT

Polyethylene-based resin foamed particles are obtained having good productivity, achieve an increase in foaming ratio, and in which a miniaturization of the average cell diameter is suppressed. A polyethylene-based resin in-mold-foam-molded body using the foamed particles is reduced in yellowing of the surface of the molded body and has favorable surface beauty (surface smoothness). The foamed particles contain, as a base resin, a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds, in which the Z average molecular weight is 30×10⁴ or more and 100×10⁴ or less, the surface layer film thickness is 11 μm or more and 120 μm or less, and the open-cell ratio is 12% or less.

### TECHNICAL FIELD

The present invention relates to polyethylene-based resin foamed particles for use in, for example, shock absorbing materials, shock absorbing packaging materials, reusable shipping cartons, thermal insulating materials, and the like, a polyethylene-based resin in-mold-foam-molded body obtained by in-mold foam molding the polyethylene-based resin foamed particles, and a method for producing the polyethylene-based resin foamed particles.

### BACKGROUND ART

A polyethylene-based resin in-mold-foam-molded body obtained by filling polyethylene-based resin foamed particles into a mold, and then thermally molding the same with steam and the like has features, such as freedom in shapes, lightweight properties, and thermal insulation properties, as the advantages.

Various methods are known as a method for producing the polyethylene-based resin foamed particles.

Patent Document 1 discloses a method including dispersing linear low density polyethylene-based resin particles in an aqueous dispersion medium together with an organic volatile foaming agent, warming and pressurizing the resultant linear low density polyethylene-based resin particles to impregnate the same with the organic volatile foaming agent, and then releasing the linear low density polyethylene-based resin particles to a low pressure zone for foaming to thereby obtain linear low density polyethylene-based resin foamed particles. Herein, the organic volatile foaming agent used as the foaming agent has high foaming power among foaming agents.

Patent Document 2 discloses a method including dispersing polyethylene-based resin particles in an aqueous dispersion medium together with carbon dioxide (dry ice), warming and pressurizing the resultant polyethylene-based resin particles to impregnate the same with the carbon dioxide, and then releasing the resultant polyethylene-based resin particles to a low pressure zone for foaming to thereby obtain polyethylene-based resin foamed particles having an cell diameter of 250 μm or more, two melting peak temperatures of a melting peak temperature on the low-temperature side and a melting peak temperature on the high-temperature side in differential scanning calorimetry (DSC), and a melting peak heat quantity on the high-temperature side of 17 to 35 J/g. The carbon dioxide used as the foaming agent herein is excellent in environmental suitability as compared with the organic volatile foaming agent but has a foaming power lower than that of the organic volatile foaming agent.

In particular, Patent Document 1 and Patent Document 2 disclose the use of calcium stearate for neutralizing a residue of a catalyst used in polymerization of a polyethylene-based resin and an antioxidant for preventing oxidation degradation of resin. As the antioxidant, a phenol-based antioxidant (“IRGANOX”, Registered Trademark, which similarly applies to the following description) 1010) and a phosphorus-based antioxidant (Phosphite 168) are specifically mentioned.

However, Patent Documents 1 and 2 also disclose that the calcium stearate and the antioxidants have the action as a foam nucleating agent, and therefore when the addition amount thereof increases, the cell diameter of the foamed particles to be obtained is miniaturized, which results in degradation of the surface smoothness and the like of a foam-molded body. Therefore, Patent Document 1 discloses that the addition amount of the calcium stearate is preferably 20 to 300 ppm in order to control the cell diameter of the foamed particles to 0.02 to 2.0 mm. In Examples, 170 ppm of calcium stearate, 250 ppm of IRGANOX 1010, and 750 ppm of Phosphite 168, i.e., 1170 ppm in total, (Total amount of IRGANOX 1010 and Phosphite 168 is 1000 ppm.) are blended in a polyethylene-based resin.

Patent Document 2 discloses that the addition amount of the calcium stearate and the like is 1500 ppm or less and particularly preferably 900 ppm or less. In Examples, 700 ppm of calcium stearate, 300 ppm of phenol-based antioxidant, and 500 ppm of phosphorus-based antioxidant, i.e., 1500 ppm in total, (Total amount of the phenol-based antioxidant and the phosphorus-based antioxidant is 800 ppm.) are blended in a polyethylene-based resin.

Moreover, Patent Document 2 suggests that, in an extrusion process of obtaining resin particles which is an upstream process of obtaining foamed particles, the melt index and the melt tension of a raw material resin change due to the temperature conditions of pelletizing and the like, and that when particularly the resin temperature exceeds 250° C., resin degradation, such as decomposition and crosslinking, of the polyethylene-based resin occurs, so that foamed particles having a high foaming ratio are not obtained. In order to prevent such disadvantages, Patent Document 2 discloses a method for performing pelletizing at a resin temperature of 250° C. or less to obtain resin particles.

However, in the case of performing pelletizing at a resin temperature of 250° C. or less to obtain resin particles in the extrusion process, the melt viscosity of the polyethylene-based resin becomes high, so that a load to an extruder increases, which poses a problem in that the production amount of the resin particles per unit time needs to be limited to be low.

When resin particles are produced at a resin temperature exceeding 250° C. in order to increase the production amount of the resin particles per unit time, foamed particles having a high foaming ratio cannot be obtained due to the reduction in melt index and the increase in melt tension as described above. On the other hand, when a large amount of an antioxidant is added in order to avoid the disadvantages, the number of cells of the foamed particles to be obtained by foaming resin particles exceeds the required number of cells because the antioxidant also acts as a foam nucleating agent, so that a problem in that the membrane thickness of a surface layer portion of the foamed particles becomes small to degrade the beauty of the surface and the like of a polyethylene-based resin in-mold-foam-molded body remains unsolved.

Patent Documents 3 to 5 disclose polyethylene-based resin foamed particles containing polyethylene glycol and glycerin as a hydrophilic compound and describe that the surface properties and the fusibility are excellent when formed into an in-mold-foam-molded body. However, Patent Documents 3 to 5 have room for a further improvement.

In particular, it is impossible to avoid a reduction in surface properties when the amount of additives, such as talc, is large. For example, in Example 4 of Patent Document 4, the surface properties of the in-mold-foam-molded body obtained by adding 0.1 parts by weight (1000 ppm) of talc are not good. Therefore, in Example 10 thereof, in order to improve the surface properties, a low density polyethylene-based resin having a low melting point is blended in a linear low density polyethylene.

Patent Document 6 and Patent Document 7 disclose polyethylene-based resin foamed particles obtained when the addition amount of additives is large. Specifically, Examples 1 to 3 of Patent Document 6 and Examples 1 to 3 of Patent Document 7 describe polyethylene-based resin foamed particles (preliminary foamed particles) to which 0.12 parts by weight (1200 ppm) of talc as an inorganic substance is added and describe an example in which the open-cell ratio is 12% or less but the average cell diameter is as small as 198 μm or less, which show a result that the number of cells is very large, and thus the membrane thickness of a surface layer portion of the polyethylene-based resin foamed particle becomes small. Therefore, it cannot be said that the surface properties of the polyethylene-based resin in-mold-foam-molded body obtained from such polyethylene-based resin foamed particles are sufficiently beautiful, and thus the techniques have room for an improvement.

The average cell diameter in Patent Document 6 and Patent Document 7 is determined in accordance with ASTM D 3576 and is a value determined as “L/n/0.616” when the number of cells present on a fixed length L is set to n. Therefore, it should be noted that the value obtained as “L/n” is simply multiplied by 1.623 (divided by 0.616). More specifically, in Patent Document 6 and Patent Document 7, although the average cell diameter of 198 μm is apparently large, the average cell diameter calculated by L/n is as small as 122 μm.

Moreover, a polyethylene-based resin in-mold-foam-molded body obtained from former polyethylene-based resin foamed particles has also a problem in that the surface turns yellow in an in-mold foam molding process, so that the commercial value decreases. Such yellowing is considered to result from the phenol-based antioxidant added as an antioxidant. In order to prevent the yellowing, Patent Document 8 or Patent Document 9 describes the use of a phosphorus-based antioxidant in combination. However, Patent Document 8 and Patent Document 9 do not relate to a resin foam-molded body. Therefore, simply applying these techniques to polyethylene-based resin foamed particles causes the same problems as the problems described above in that the membrane thickness of a surface layer portion of the polyethylene-based resin foamed particles becomes small and the beauty of the surface of an in-mold-foam-molded body decreases.

Patent Documents 1 to 9 do not disclose techniques referring to the Z average molecular weight (Mz) of polyethylene-based resin.

Patent Document 10 describes a foam-molded body containing an ethylene (co)polymer having specific molecular weight distribution (Mw/Mn). Patent Document 10 discloses an ethylene (co)polymer having a Z average molecular weight (Mz) of 82×10⁴ or more in Examples but does not relate to a foam-molded body.

Patent Document 11 describes a foam-molded body containing an ethylene copolymer having a specific molecular weight distribution (Mz/Mw) but does not specifically describe the Z average molecular weight (Mz). Moreover, a foam-molded body is also a foam-molded body obtained by kneading an ethylene copolymer and a foaming agent, and then performing extrusion foaming, foaming in an oven, or press foaming of the kneaded substance. Therefore, the invention described in Patent Document 11 does not relate to foamed particles obtained by impregnating resin particles with a foaming agent, and then foaming the resultant resin particles.

Thus, when the foaming methods vary, base resin completely different in resin properties is used. Therefore, it is difficult to apply the technical contents described in Patent Document 11 to the technical field of foamed particles.

Patent Document 12 also describes a crosslinked foam-molded body containing an ethylene copolymer having a specific molecular weight distribution (Mz/Mw) but does not specifically describe the Z average molecular weight (Mz). The foam-molded body is also a foam-molded body obtained by performing crosslinking with ejection foaming or press foaming. Therefore, Patent Document 12 does not relate to foamed particles obtained by impregnating resin particles with a foaming agent, and then foaming the resultant resin particles. Thus, when the foaming methods vary, base resin completely different in resin properties is used. Therefore, it is difficult to apply the technical contents described in Patent Document 12 to the technical field of foamed particles.

On the other hand, Patent Documents 13 to 15 describe the Z average molecular weight of a base resin for use in not polyethylene-based resin foamed particles but polypropylene-based resin foamed particles or polystyrene-based resin foamed particles.

However, the polypropylene-based resin or the polystyrene-based resin is completely different from the polyethylene-based resin in the melting properties such as the melting point and the melt index, the crystal structure and the like of the resin, and further the foaming conditions such as the foaming temperature. From the facts described above, it is also difficult to directly apply the Z average molecular weight of the polypropylene-based resin or the polystyrene-based resin to the Z average molecular weight of the polyethylene-based resin.

Patent Documents 16 to 18 disclose that polyethylene-based resin of various Z average molecular weights can be produced, and those available as commercially-available items are also known.

On the other hand, Patent Document 19 discloses polyolefin-based resin foamed particles having an apparent membrane thickness per cell of 4 to 26 μm, instead of the membrane thickness of a surface layer of foamed particles. However, the foaming ratio of the foamed particles in Patent Document 19 is very low of 1.5 to 3.8 times (cm³/g). In the case of such a low ratio, the membrane thickness becomes large without the use of a special technique.

### CITATION LIST

### Patent Literatures

Patent Document 1: JP-A No. H02-53837

Patent Document 2: JP-A No. 2000-17079

Patent Document 3: International Publication WO 2009/075208

Patent Document 4: International Publication WO 2011/086937

Patent Document 5: International Publication WO 2011/086938

Patent Document 6: JP-A No. H10-204203

Patent Document 7: JP-A No. H10-237211

Patent Document 8: JP-A No. H10-202720

Patent Document 9: JP-A No. 2001-172438

Patent Document 10: International Publication WO 2000/078828

Patent Document 11: International Publication WO 2000/024822

Patent Document 12: International Publication WO 2010/137719

Patent Document 13: JP-A No. 2000-198872

Patent Document 14: JP-A No. H08-259724

Patent Document 15: JP-A No. H06-25458

Patent Document 16: JP-T No. 2004-506049

Patent Document 17: International Publication WO 2006/080578

Patent Document 18: JP-A No. 2007-161787

Patent Document 19: JP-A No. H04-372630

### SUMMARY OF INVENTION

### Technical Problem

The present invention has been made in view of the problems described above and the like. In particular, it is an object of the present invention to provide polyethylene-based resin foamed particles whose surface properties when subjected to in-mold foam molding are more stable and more beautiful than before.

It is another object of the present invention to provide polyethylene-based resin foamed particles which are obtained by foaming polyethylene-based resin particles for foaming which have good productivity and which achieve an increase in foaming ratio and in which a reduction in film thickness of a surface layer portion of the polyethylene-based resin foamed particles is suppressed and resin degradation is suppressed even when an additive is added in a relatively large addition amount of 1000 ppm or more and 4000 ppm or less.

It is still another object of the present invention to reduce yellowing of the surface of a molded body, obtained from the polyethylene-based resin foamed particles, in in-mold foam molding.

### Solution to Problem

The present inventors have conducted extensive researches and, as a result, have found that the above-described problems can be solved by polyethylene-based resin foamed particles containing, as a base resin, a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds, in which the Z average molecular weight is 30×10⁴ or more and 100×10⁴ or less, the surface layer film thickness is 11 μm or more and 120 μm or less, and the open-cell ratio is 12% or less, and thus, the present invention has been accomplished.

More specifically, the present invention includes the following configurations.

[1] Polyethylene-based resin foamed particles containing, as a base resin, a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds, in which the Z average molecular weight is 30×10⁴ or more and 100×10⁴ or less, the surface layer film thickness is 11 μm or more and 120 μm or less, and the open-cell ratio is 12% or less.
[2] The polyethylene-based resin foamed particles described in [1], in which the Z average molecular weight is 40×10⁴ or more and 80×10⁴ or less.
[3] The polyethylene-based resin foamed particles described in [1] or [2], in which the Z average molecular weight is 40×10⁴ or more and 70×10⁴ or less.
[4] The polyethylene-based resin foamed particles described in any one of [1] to [3], in which the hydrophilic compound is glycerin and/or polyethylene glycol.
[5] The polyethylene-based resin foamed particles described in any one of [1] to [4], in which the surface layer film thickness of the polyethylene-based resin foamed particles is 11 μm or more and 100 μm or less.
[6] The polyethylene-based resin foamed particles described in any of [1] to [4], in which the surface layer film thickness of the polyethylene-based resin foamed particles is 12 μm or more and 80 μm or less.
[7] The polyethylene-based resin foamed particles described in any one of [1] to [6], in which the foaming ratio of the polyethylene-based resin foamed particles is 5 times or more and 45 times or less.
[8] The polyethylene-based resin foamed particles described in any one of [1] to [7], in which the total content of one or more compounds selected from the group consisting of antioxidants, metal stearates, and inorganic substances is 1600 ppm or more and 3700 ppm or less.
[9] The polyethylene-based resin foamed particles described in any one of [1] to [8], in which the average cell diameter of the polyethylene-based resin foamed particles is 180 μm or more and 450 μm or less.
[10] The polyethylene-based resin foamed particles described in any one of [1] to [9], in which the antioxidants in the polyethylene-based resin composition include a phosphorus-based antioxidant and a phenol-based antioxidant and satisfy the following (a1) and (a2) conditions: (a1) the content of the phosphorus-based antioxidant contained in the polyethylene-based resin composition is 500 ppm or more and 1500 ppm or less; and (a2) the ratio of the content of the phosphorus-based antioxidant to the content of the phenol-based antioxidant (content of phosphorus-based antioxidant/content of phenol-based antioxidant) contained in the polyethylene-based resin composition is 2.0 or more and 7.5 or less.
[11] The polyethylene-based resin foamed particles described in [10], in which the ratio of the content of the phosphorus-based antioxidant to the content of the phenol-based antioxidant is 2.5 or more and 5.0 or less.
[12] The polyethylene-based resin foamed particles described in any one of [1] to [11], in which the total content of the phosphorus-based antioxidant and the phenol-based antioxidant contained in the polyethylene-based resin composition is 800 ppm or more and 1900 ppm or less.
[13] The polyethylene-based resin foamed particles described in any one of [1] to [12], in which the polyethylene-based resin composition contains metal stearate and the content of the metal stearate contained in the polyethylene-based resin composition is 200 ppm or more and 700 ppm or less.
[14] The polyethylene-based resin foamed particles described in any one of [1] to [13], in which the polyethylene-based resin composition contains an inorganic substance and the content of the inorganic substance contained in the polyethylene-based resin composition is 100 ppm or more and 2500 ppm or less.
[15] The polyethylene-based resin foamed particles described in any one of [1] to [14], in which the average cell diameter is 200 μm or more and 400 μm or less.
[16] The polyethylene-based resin foamed particles described in any one of [1] to [15], in which the polyethylene-based resin at least contains a linear low density polyethylene-based resin.
[17] A polyethylene-based resin in-mold-foam-molded body, which is obtained by in-mold foam molding the polyethylene-based resin foamed particles described in any one of [1] to [16].
[18] A method for producing polyethylene-based resin foamed particles having a Z average molecular weight of 30×10⁴ or more and 100×10⁴ or less, a surface layer film thickness of 11 μm or more and 120 μm or less, and an open-cell ratio of 12% or less, and the method includes the following first-stage foaming process:
first-stage foaming process of dispersing polyethylene-based resin particles for foaming containing a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds together with a foaming agent in an aqueous dispersion medium in an airtight container, heating the resultant polyethylene-based resin particles for foaming to a temperature equal to or higher than the softening point of the polyethylene-based resin particles for foaming, pressurizing the same, and then releasing the resultant polyethylene-based resin particles for foaming to a pressure zone in which the pressure is lower than the internal pressure of the airtight container to thereby produce polyethylene-based resin foamed particles.
[19] A method for producing polyethylene-based resin foamed particles having a Z average molecular weight of 30×10⁴ or more and 100×10⁴ or less, a portion with a surface layer film thickness of 11 μm or more and 120 μm or less, and an open-cell ratio of 12% or less, and the method includes the following first-stage foaming process and second-stage foaming process: first-stage foaming process of dispersing polyethylene-based resin particles for foaming containing a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds together with carbon dioxide in an aqueous dispersion medium in an airtight container, heating the resultant polyethylene-based resin particles for foaming to a temperature equal to or higher than the softening point of the polyethylene-based resin particles for foaming, pressurizing the same, and then releasing the resultant polyethylene-based resin particles for foaming to a pressure zone in which the pressure is lower than the internal pressure of the airtight container to thereby produce polyethylene-based resin foamed particles; and second-stage foaming process of placing the polyethylene-based resin foamed particles obtained in the first-stage foaming process into a pressure resistant container, impregnating the polyethylene-based resin foamed particles with inorganic gas containing at least one kind of gas selected from the group consisting of air, nitrogen, and carbon dioxide to give internal pressure, and then heating the polyethylene-based resin foamed particles for further foaming.
[20] The method for producing polyethylene-based resin foamed particles described in [18] or [19], in which the antioxidants in the polyethylene-based resin composition include a phosphorus-based antioxidant and a phenol-based antioxidant and satisfy the following (a1) and (a2) conditions, (a1) the content of the phosphorus-based antioxidant contained in the polyethylene-based resin composition is 500 ppm or more and 1500 ppm or less, and (a2) the ratio of the content of the phosphorus-based antioxidant to the content of the phenol-based antioxidant (content of phosphorus-based antioxidant/content of phenol-based antioxidant) contained in the polyethylene-based resin composition is 2.0 or more and 7.5 or less.
[21] The method for producing polyethylene-based resin foamed particles described in any one of [18] to [20], in which the polyethylene-based resin particles for foaming are obtained by being melt and kneaded by an extruder in a resin temperature range from 250° C. or higher to 320° C. or less.

### Advantageous Effects of Invention

The polyethylene-based resin foamed particles of the present invention can demonstrate an effect of providing polyethylene-based resin foamed particles which are obtained by foaming polyethylene-based resin particles for foaming which have good productivity and achieve an increase in foaming ratio and in which the surface layer film thickness is large and a miniaturization of the average cell diameter and resin degradation are suppressed, even when one or more compounds selected from the group consisting of antioxidants, metal stearates, and inorganic substances contained in the polyethylene-based resin composition as a base resin of the polyethylene-based resin foamed particles are added in a relatively wide addition amount range in which the total content is 1000 ppm or more and 4000 ppm or less.

The polyethylene-based resin in-mold-foam-molded body obtained by in-mold foam molding using the polyethylene-based resin foamed particles having a large surface layer film thickness is a foam-molded body excellent in surface properties (surface beauty) and fusibility.

Particularly when the amount of the antioxidant is a specific amount in the present invention, the effect of suppressing resin degradation of the polyethylene-based resin composition is high. Therefore, in an extrusion process when producing the polyethylene-based resin particles for foaming, good polyethylene-based resin particles for foaming can be produced in which resin degradation, such as decomposition and crosslinking, is suppressed even at a high resin temperature of 250° C. or higher. Moreover, since the extrusion at a high resin temperature of 250° C. or higher can be performed, a load to an extruder is also reduced and the productivity (the discharge amount) can be increased.

Moreover, the polyethylene-based resin in-mold-foam-molded body obtained by in-mold foam molding the polyethylene-based resin foamed particles demonstrates an effect of reducing yellowing of the molded body surface in the in-mold foam molding.

Furthermore, the method for producing polyethylene-based resin foamed particles of the present invention demonstrates an effect of producing polyethylene-based resin foamed particles in which the surface layer film thickness is large and resin degradation is suppressed due to the fact that a hydrophilic compound is blended in the polyethylene-based resin composition, even when carbon dioxide which is a foaming agent having a relatively low foaming power is used and a phosphorus-based antioxidant and a phenol-based antioxidant are contained in a relatively large amount. Moreover, the polyethylene-based resin foamed particles to be obtained achieve an increase in foaming ratio.

### BRIEF DESCRIPTION OF THE DRAWINGS

FIG. 1 is an enlarged view of a surface layer portion of polyethylene-based resin foamed particles according to this embodiment (second-stage foamed particles of Example 16). The thinnest portion in the thickest surface layer film is a portion sandwiched by the thick arrows and the thickness (surface layer film thickness) is 65 μm.

FIG. 2 is an enlarged view of a surface layer portion of former polyethylene-based resin foamed particles (first-stage foamed particles of Comparative Example 6), which do not relate to this embodiment. The thinnest portion in the thickest surface layer film is a portion sandwiched by the white arrows and the thickness (surface layer film thickness) is 10 μm.

FIG. 3 is an enlarged view of a cross section obtained by cutting a polyethylene-based resin in-mold-foam-molded body according to this embodiment with a band saw. The outline (surface layer portion of the polyethylene-based resin foamed particles) of the polyethylene-based resin foamed particles of the present invention constituting the polyethylene-based resin in-mold-foam-molded body can be seen and presents a characteristic pattern like a hexagonal pattern.

FIG. 4 is an enlarged view of a cross section obtained by cutting a former polyethylene-based resin in-mold-foam-molded body, which does not relate to this embodiment, with a slicer. The outline of the polyethylene-based resin foamed particles constituting the polyethylene-based resin in-mold-foam-molded body is not seen and does not present a characteristic pattern.

FIG. 5 is a graph showing an example of a DSC curve obtained by differential scanning calorimetry (DSC) of the polyethylene-based resin foamed particles according to this embodiment. The polyethylene-based resin foamed particles have two melting peak temperature of a melting peak temperature on the low-temperature side and a melting peak temperature on the high-temperature side.

### DESCRIPTION OF EMBODIMENTS

Polyethylene-based resin foamed particles of the present invention have a configuration of containing, as a base resin, a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds, in which the Z average molecular weight (hereinafter sometimes also referred to as “Mz”) is 30×10⁴ or more and 100×10⁴ or less, the surface layer film thickness is 11 μm or more and 120 μm or less, and the open-cell ratio is 12% or less.

One embodiment according to the present invention is described as follows. However, the present invention is not limited thereto and can be implemented in aspects which are variously modified in the range of the described scope.

The polyethylene-based resin foamed particles according to the present invention contain, as a base resin, a polyethylene-based resin composition containing 1000 ppm or more and 4000 ppm or less in total of one or more compounds selected from the group consisting of antioxidants, metal stearates, and inorganic substances.

The antioxidant is used in order to suppress degradation in processing the polyethylene-based resin composition. The antioxidant includes a phosphoric acid-based antioxidant and a phenol-based antioxidant. When the addition amount of the phosphorus-based antioxidant among the antioxidants is increased, yellowing of the surface of a molded body in in-mold foam molding can be further suppressed.

The metal stearate is used for the purpose of, for example, neutralizing a residue of a catalyst for use in the polymerization of the polyethylene-based resin, and also has a function of suppressing resin degradation and also suppressing corrosion of an extruder or a molding machine to which the polyethylene-based resin composition is supplied.

The inorganic substance is used in order to increase the foaming ratio of the polyethylene-based resin foamed particles and also uniform the cell diameters.

In the present invention, one or more of compounds selected from the group consisting of antioxidants, metal stearates, and inorganic substances may be used. In order to achieve all the above-described objects, it is preferable to blend all of the antioxidants, the metal stearates, and the inorganic substances in the polyethylene-based resin composition.

However, it is also possible to use hydrotalcite and the like having an action equivalent to the action of metal stearate in combination with an antioxidant or an inorganic substance and not to use metal stearate.

In the present invention, the total content of one or more compounds selected from the group consisting of antioxidants, metal stearates, and inorganic substances needs to be 1000 ppm or more. When the total content is less than 1000 ppm, each of the objects cannot be achieved.

On the other hand, antioxidants, metal stearates, and inorganic substances are generally likely to act as a foam nucleating agent in foaming, and thus promote a reduction in the surface layer film thickness of the polyethylene-based resin foamed particles. When the total content of one or more compounds selected from the group consisting of antioxidants, metal stearates, and inorganic substances particularly exceeds 4000 ppm, there is a tendency for the average cell diameter of the polyethylene-based resin foamed particles to be miniaturized or for the surface layer film thickness of the polyethylene-based resin foamed particles to decrease, which results in the fact that the surface beauty of the polyethylene-based resin in-mold-foam-molded body to be obtained tends to decrease.

Thus, the total content of one or more compounds selected from the group consisting of antioxidants, metal stearates, and inorganic substances is 1000 ppm or more and 4000 ppm or less, preferably 1100 ppm or more and 3900 ppm or less, and more preferably 1600 ppm or more and 3700 ppm or less.

In the present invention, a hydrophilic compound is blended in a proportion of 50 ppm or more and 20000 ppm or less in the polyethylene-based resin composition as a base resin.

In the present invention, in a process of dispersing polyethylene resin particles for foaming described later (which refer to non-foamed polyethylene-based resin particles before obtaining polyethylene-based resin foamed particles and are described later in detail) in a water dispersion system, the polyethylene-based resin particles for foaming are impregnated with water, carbon dioxide, and the like which act as a foaming agent. The hydrophilic compound has a function of holding such water, carbon dioxide, and the like in the particles to facilitate an increase in foaming ratio of the polyethylene-based resin foamed particles to be obtained.

Moreover, it is assumed in the polyethylene-based resin particles for foaming containing the hydrophilic compound that, in the process of dispersing the polyethylene-based resin particles for foaming in a water dispersion system, the hydrophilic compound is somewhat eluted into water from the surface layer portion of the polyethylene-based resin particles for foaming, so that the hydrophilic compound concentration in the surface layer portion of the polyethylene-based resin particles for foaming decrease, which results in the fact that the surface layer film thickness of the polyethylene-based resin foamed particles when formed into polyethylene-based resin foamed particles tends to increase. When in-mold foam molding the polyethylene-based resin foamed particles having a large surface layer film thickness, the resin of the surface layer portion sufficiently elongates, so that an in-mold-foam-molded body is obtained which is free from irregularities (irregularities resulting from dents formed between the polyethylene-based resin foamed particles) of the surface of the in-mold-foam-molded body, and thus has a beautiful surface.

The hydrophilic compound in the present invention may be a water-soluble compound or a water-absorbing compound and is preferably a water-soluble compound.

More specifically, the hydrophilic compound is preferably a water-soluble compound having a solubility in water (the weight in terms of gram of the hydrophilic compound dissolved in 100 g of water at 23° C. under atmospheric pressure) of 0.01 g/100 g of water or more. The upper limit of the solubility is not limited and a compound which is freely mixed with water may be acceptable.

The water-soluble compound having a solubility in water of 0.01 g/100 g of water or more specifically includes organic compounds having a hydroxyl group such as glycerin, polyethylene glycol, 1,2,4-butanetriol, diglycerin, pentaerythritol, trimethylol propane, sorbitol, D-mannitol, erythritol, hexanetriol, xylitol, D-xylose, inositol, fructose, galactose, glucose, mannose, and aliphatic alcohols having carbon atoms of 10 or more and 25 or less; glycerin esters of fatty acids having carbon atoms of 10 or more 25 or less; triazine organic substances, such as melamine, isocyanuric acid, and a melamine-isocyanuric acid condensate; water-soluble inorganic substances such as sodium chloride, calcium chloride, magnesium chloride, borax, calcium borate, and zinc borate; and the like but is not limited thereto. These substances may be used alone or in combination of two or more of kinds thereof.

As the hydrophilic compound in the present invention, an aspect is also preferable in which the hydrophilic compound is present in the form of liquid at 150° C. or less which is almost a foaming temperature when obtaining polyethylene-based resin foamed particles. Such a compound is preferable because the effect of miniaturizing the average cell diameter of the polyethylene-based resin foamed particles is low, so that polyethylene-based resin foamed particles with a large average cell diameter are easily obtained and the surface layer film thickness tends to become large.

Among the hydrophilic compounds mentioned above, water-soluble compounds containing at least one substance selected from the group consisting of glycerin, polyethylene glycol, and glycerin esters of fatty acids having carbon atoms of 10 or more and 25 or less are more preferable because the surface beauty of the in-mold-foam-molded body and also the polyethylene-based resin foamed particles having a high foaming ratio described above can be easily obtained. Furthermore, from the point that the surface beauty of the in-mold-foam-molded body and the polyethylene-based resin foamed particles having a high foaming ratio are easily obtained at a low compound content, glycerin and polyethylene glycol are still more preferable and glycerin is the most preferable.

The polyethylene glycol for use in the present invention is a nonionic water-soluble polymer having a structure in which ethylene glycols are polymerized and the molecular weight is about 50,000 or less.

The average molecular weight of the polyethylene glycol for use in the present invention is more preferably 200 or more and 9000 or less and still more preferably 200 or more and 600 or less.

The glycerin esters of fatty acids having carbon atoms of 10 or more and 25 or less for use in the present invention are more preferably monoesters, diesters, or triesters containing stearic acid and glycerin and are still more preferably mixtures of esters thereof.

The content of the hydrophilic compound in the present invention is 50 ppm or more and 20000 ppm or less, preferably 100 ppm or more and 20000 ppm or less, and still more preferably 500 ppm or more and 5000 ppm or less. When the content of the hydrophilic compound is less than 50 ppm, the foaming ratio tends to be difficult to increase and the surface layer film thickness of the polyethylene-based resin foamed particles tends to be difficult to increase. Even when the hydrophilic compound is blended in a proportion exceeding 20000 ppm, a further increase in the foaming ratio tends to be difficult to develop. In the case of glycerin which is liquid at normal temperature and the like, even when glycerin is attempted to be blended in a proportion exceeding 20000 ppm, a stable extrusion operation tends not to be able to perform, e.g., occurrence of strand cutting, in a process of obtaining polyethylene-based resin particles for foaming using an extruder described later.

In the present invention, by setting the Mz of the polyethylene-based resin foamed particles to 30×10⁴ or more and 100×10⁴ or less, even when antioxidants, metal stearates, and inorganic substances which are likely to promote the miniaturization of the average cell diameter are contained, the miniaturization of the average cell diameter of the polyethylene-based resin foamed particles can be suppressed and the surface layer film thickness does not decrease.

More specifically, in the present invention, the total content of one or more compounds selected from the group consisting of antioxidants, metal stearates, and inorganic substances is 1000 ppm or more and 4000 ppm or less and also the Mz of the polyethylene-based resin foamed particles is 30×10⁴ or more and 100×10⁴ or less, preferably 40×10⁴ or more and 80×10⁴ or less, and more preferably 40×10⁴ or more and 70×10⁴ or less.

When the Mz of the polyethylene-based resin foamed particles exceeds 100×10⁴, there is a tendency for the average cell diameter to be remarkably miniaturized and also the melt viscosity increases. Therefore, the elongation of the resin in in-mold foam molding tends to decrease, so that the surface beauty of the polyethylene-based resin in-mold-foam-molded body to be obtained tends to decrease. When the Mz exceeds 100×10⁴, an increase in foaming ratio of the polyethylene-based resin foamed particles also tends to be difficult to achieve.

On the other hand, when the Mz of the polyethylene-based resin foamed particles is less than 30×10⁴, there is a tendency for the open-cell ratio of the polyethylene-based resin foamed particles to increase and also there is a tendency for the compression stress of the polyethylene-based resin in-mold-foam-molded body obtained by in-mold foam molding the polyethylene-based resin foamed particles to decrease.

The Mz of the polyethylene-based resin which is a raw material constituting the polyethylene-based resin composition for use in the present invention or the Mz of the polyethylene-based resin particles for foaming is not particularly limited. However, in order to set the Mz of the polyethylene-based resin foamed particles to 30×10⁴ or more and 100×10⁴ or less, it is preferable to set the Mz of the polyethylene-based resin as a raw material or the Mz of the polyethylene-based resin particles for foaming to about 30×10⁴ or more and 100×10⁴ or less.

However, when producing the polyethylene-based resin particles for foaming by an extrusion process with an extruder, there is a tendency for the molecular weight of the polyethylene-based resin to become somewhat high by the extrusion process. Therefore, considering the tendency, it is more preferable to use, as a base resin, a polyethylene-based resin having an Mz slightly lower (lower by about 1×10⁴ to 2×10⁴) than the desired Mz of the polyethylene-based resin particles for foaming or the polyethylene-based resin foamed particles.

The Mz of the polyethylene-based resin particles for foaming and the Mz of polyethylene-based resin foamed particles almost coincide with each other. More specifically, molecular weight changes in the process of forming the polyethylene-based resin particles for foaming into the polyethylene-based resin foamed particles are hardly observed.

The above-described polyethylene-based resin different in Mz is available from polyethylene-based resin manufacturers. For example, Patent Documents 16 to 18 described above, JP-A No. 2009-173798, JP-A No. 2009-197226, or JP-A No. 2011-099092 disclose/discloses a production method and the like of polyethylene-based resin different in Mz. By inquiring about the polyethylene-based resin from polyethylene-based resin manufacturers based on such information, the polyethylene-based resin is available as a commercially-available item or a trial product.

The polyethylene-based resin as a base resin for use in the present invention includes a high density polyethylene-based resin, a medium density polyethylene-based resin, a low density polyethylene-based resin, a linear low density polyethylene-based resin, and the like. Among the various kinds of resin, it is more preferable to use a linear low density polyethylene-based resin from the point that the polyethylene-based resin foamed particles of high foaming ratio are obtained. Moreover, it is also possible to blend two or more kinds of linear low density polyethylene-based resin different in density for use. Furthermore, it is also possible to blend, in a linear low density polyethylene-based resin, one or more kinds of resin selected from the group consisting of a high density polyethylene-based resin, a medium density polyethylene-based resin, and a low density polyethylene-based resin for use.

Blending two or more kinds of polyethylene-based resin for use is a more preferable aspect in the present invention because an extension of the pressure range in which molding can be performed in the case of performing in-mold foam molding is facilitated. In particular, it is more preferable to blend a linear low density polyethylene-based resin and a low density polyethylene-based resin for use.

The linear low density polyethylene-based resin for use in the present invention is more preferably one having a melting point of 115° C. or higher and 130° C. or less, a density of 0.915 g/cm³ or more and 0.940 g/cm³ or less, and a melt index of 0.1 g/10 min or more and 5 g/10 min or less, for example. Herein, the melt index in the present invention is a value measured at a temperature of 190° C. and a load of 2.16 kg in accordance with JIS K7210.

The linear low density polyethylene-based resin for use in the present invention may contain, other than ethylene, a comonomer which can be copolymerized with ethylene. As the comonomer which can be copolymerized with ethylene, α-olefin having carbon atoms of 4 or more and 18 or less can be used. For example, 1-butene, 1-pentene, 1-hexene, 3,3-dimethyl-1-butene, 4-methyl-1-pentene, 4,4-dimethyl-1-pentene, 1-octene, and the like are mentioned. These comonomers may be used alone or in combination of two or more kinds thereof.

In order to set the density of the copolymer within the range mentioned above, when the linear low density polyethylene-based resin is a copolymer, it is preferable to use the comonomers in a proportion of about 1% by weight or more and 12% by weight or less for copolymerization.

The low density polyethylene-based resin for use in the present invention is more preferably one having a melting point of 100° C. or higher and 120° C. or less, a density of 0.910 g/cm³ or more and 0.930 g/cm³ or less, and a melt index of 0.1 g/10 min or more and 100 g/10 min or less, for example.

The low density polyethylene-based resin for use in the present invention may contain, other than ethylene, a comonomer which can be copolymerized with ethylene. As the comonomer which can be copolymerized with ethylene, α-olefin having carbon atoms of 4 or more and 18 or less can be used. For example, 1-butene, 1-pentene, 1-hexene, 3,3-dimethyl-1-butene, 4-methyl-1-pentene, 4,4-dimethyl-1-pentene, 1-octene, and the like are mentioned. These comonomers may be used alone or in combination of two or more kinds thereof.

The polyethylene-based resin foamed particles in the present invention are obtained by foaming the polyethylene-based resin particles for foaming. Herein, the polyethylene-based resin particles for foaming can be obtained by placing a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds in an extruder, melting and kneading the composition, extruding the composition in the shape of a strand, and then cutting the strand-shaped composition into a particle shape.

In the case of increasing the resin temperature in the extrusion to be as high as 250° C. or higher in order to increase the productivity (discharge amount) per unit time when producing the polyethylene-based resin particles for foaming by the extrusion process with an extruder, it is preferable to increase the addition amount of the antioxidant from the viewpoint of suppressing resin degradation, such as decomposition and crosslinking, of the polyethylene-based resin. Moreover, it is preferable to increase the addition amount of a phosphorus-based antioxidant from the viewpoint of suppressing yellowing of the polyethylene-based resin in-mold-foam-molded body.

When increasing the addition amount of the antioxidant for use in the present invention, it is preferable to use a phosphorus-based antioxidant and a phenol-based antioxidant as an antioxidant in combination.

The content of the phosphorus-based antioxidant contained in the polyethylene-based resin composition is more preferably 500 ppm or more and 1500 ppm or less, still more preferably 600 ppm or more and 1400 ppm or less, and particularly preferably 800 ppm or more and 1200 ppm or less.

By setting the content of the phosphorus-based antioxidant to 500 ppm or more, the resin degradation can be made difficult to occur when obtaining the polyethylene-based resin particles for foaming by the extrusion process, the resin degradation can be prevented even under the conditions where the resin temperature is 250° C. or higher at which the resin degradation is likely to occur, and yellowing of the polyethylene-based resin in-mold-foam-molded body obtained by in-mold foam molding can also be suppressed.

On the other hand, by setting the content of the phosphorus-based antioxidant to 1,500 ppm or less, a reduction in the surface film thickness of the polyethylene-based resin foamed particles is prevented, so that the surface beauty of the polyethylene-based resin in-mold-foam-molded body can be made favorable.

In the present invention, when the phosphorus-based antioxidant and the phenol-based antioxidant are used in combination as an antioxidant, the ratio of the content of the phosphorus-based antioxidant to the content of the phenol-based antioxidant contained in the polyethylene-based resin composition (content of phosphorus-based antioxidant/content of phenol-based antioxidant, which is sometimes simply referred to as an “antioxidant ratio” below) is more preferably 2.0 or more and 7.5 or less and still more preferably 2.5 or more and 5.0 or less.

By setting the antioxidant ratio to 2.0 or more, yellowing of the polyethylene-based resin in-mold-foam-molded body obtained by in-mold foam molding can be notably suppressed. The cause of the yellowing is not clear but this is assumed to be because the phenol-based antioxidant changes the structure due to the pressurized steam used in the in-mold foam molding, so that the phenol-based antioxidant itself develops color.

On the other hand, by setting the antioxidant ratio to 7.5 or less, a reduction in the surface film thickness of the polyethylene-based resin foamed particles is suppressed, so that the surface beauty of the polyethylene-based resin in-mold-foam-molded body can be made favorable.

The addition amount of the phenol-based antioxidant in the case of using the phosphorus-based antioxidant and the phenol-based antioxidant in combination is more preferably an addition amount derived from the relationship between the content of the phosphorus-based antioxidant and the antioxidant ratio described above. Specifically, in the case where the polyethylene-based resin particles for foaming are obtained by the extrusion process, the content of the phenol-based antioxidant contained in the polyethylene-based resin composition is more preferably 200 ppm or more and 500 ppm or less from the viewpoint of suppressing the resin degradation and the viewpoint of suppressing the yellowing of the polyethylene-based resin in-mold-foam-molded body.

By setting the content of the phenol-based antioxidant to 200 ppm or more, the resin degradation becomes difficult to occur when obtaining the polyethylene-based resin particles for foaming by the extrusion process. By setting the content of the phenol-based antioxidant to 500 ppm or less, the miniaturization of the average cell diameter of the polyethylene-based resin foamed particles is suppressed and also the yellowing of the polyethylene-based resin in-mold-foam-molded body obtained by in-mold foam molding can be suppressed.

The total content of the phosphorus-based antioxidant and the phenol-based antioxidant in the polyethylene-based resin composition is more preferably 800 ppm or more and 1900 ppm or less from the viewpoint of suppressing the resin degradation and the yellowing.

The kinds of the phosphorus-based antioxidant and the phenol-based antioxidant for use in the present invention are not particularly limited and generally known phosphorus-based antioxidants and phenol-based antioxidants can be used.

The phosphorus-based antioxidant for use in the present invention includes, for example, tris(2,4-di-t-butyl phenyl)phosphite [Product Name: IRGAFOS (Registered Trademark, which similarly applies to the following description) 168, IRGAFOS168FF], bis(2,4-di-t-butyl phenyl)pentaerythritol diphosphite, 2-[[2,4,8,10-tetrakis(1,1-dimethylethyl)[dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine, 3,5-di-t-butyl-4-hydroxy benzyl phosphite diethylester, bis(2,6-di-t-butyl-4-methyl phenoxy)diphosphospiroundecane, bis(stearyl)diphosphospiroundecane, cyclic netopentane-tetra-yl-bis(nonylphenyl phosphite), bis(nonylphenylphenoxy)diphosphospiroundecane, 3,4,5,6-dibenzo-1,2-oxaphosphane-2-oxide, 2,4,6-tri-t-butylphenyl-2-butyl-2-ethyl-1,3-propanediolphosphite, 2,2′-methylenebis(4,6-di-t-butylphenyl)octylphosphite, bis[2,4-bis(1,1-dimethylethyl)-6-methyl-phenyl]ethylphosphite, bis(2,4-di-t-butylphenoxy)diphosphospiroundecane, trilauryl trithiophosphite, 1,1,3-tris(2-methyl-4-di-tridecylphosphite-5-t-butylphenyl)butane, 2,2′-ethylidenebis(4,6-di-t-butylphenyl)fluorophosphite, 4,4′-isopropylidenediphenol alkyl(C12-C15)phosphite, 4,4′-butylidenebis(3-methyl-6-t-butylphenyl)-di-tridecylphosphite, diphenylisodecyl phosphite, diphenylmono(tridecyl)phosphite, tris-(mono- and di-mixed nonylphenyl)phosphite, phenyl-bisphenol A pentaerythritol diphosphite, di(laurylthio)pentaerythritol diphosphite, tetrakis(2,6-di-t-butyl-4-n-octadecyloxycarbonylethyl-phenyl)-4,4′-biphenylene-di-phosphonite, tetrakis[2,6-di-t-butyl-4-(2,4′-di-t-butylphenyloxycarbonyl)-phenyl]-4,4′-biphenylene-di-phosphonite, tricetyl trithiophosphite, condensate of di-t-butylphenyl-m-cresylphosphonite and biphenyl, cyclic butylethylpropanediol-2,4,6-tri-butylphenyl phosphite, tris-[2-(2,4,8,10-tetrabutyl-5,7-dioxa-6-phospho-dibenzo-[a,c]cyclohepten-6-yl-oxy)ethyl]amine, bis(3,5-di-t-butyl-4-hydroxybenzyl ethylphosphonate)calcium, 3,9-bis[2,4-bis(1-methyl-1-phenylethyl)phenoxy]-2,4,8,10-tetraoxa-3,9-diphosphaspiro[5,5]undecane, and the like. These phosphorus-based antioxidants may be used alone or in combination of two or more kinds thereof.

The product names of these phosphorus-based antioxidants include, for example, IRGAFOS168, IRGAFOS168FF, IRGAFOS12, IRGAFOS38, Ultranox (Registered Trademark)626, PEP24G, and the like.

Among the phosphorus-based antioxidants, tris(2,4-di-t-butylphenyl)phosphite [Product Name: IRGAFOS168] is particularly preferable from the viewpoint of suppressing the resin degradation when the polyethylene-based resin particles for foaming are obtained by the extrusion process, and the viewpoint of suppressing the yellowing of the polyethylene-based resin in-mold-foam-molded body when the polyethylene-based resin particles for foaming are obtained by the extrusion process.

The phenol-based antioxidant for use in the present invention includes triethyleneglycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, pentaerythrityl.tetrakis[3-(3,5-di-t-butyl-4-hydroxyphenyl)propionate], 2,2-thio-diethylenebis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamamide), 3,5-di-t-butyl-4-hydroxybenzyl phosphonate-diethylester, 1,3,5-trimethyl-2,4,6-tris(3,5-di-t-butyl-4-hydroxybenzyl)benzene, bis(3,5-di-t-butyl-4-hydroxybenzyl ethylphosphonate) calcium, tris-(3,5-di-t-butyl-4-hydroxybenzyl)-isocyanurate, octylated diphenylamine, 2,4-bis[(octylthio)methyl]-o-cresol, 4,6-bis(octylthiomethyl)-o-cresol, 4,6-bis(dodecylthiomethyl)-o-cresol, isooctyl-3-(3,5-di-t-butyl-4-hydroxyphenyl)propionate, 2,6-di-t-butyl-4-methylphenol, tocopherol, 4-hydroxymethyl-2,6-di-t-butylphenol, 2,6-di-t-butyl-4-ethylphenol, 2,6-di-t-butyl-4-methoxyphenol, 2,2′-methylenebis(4-methyl-6-t-butylphenol), 2,2′-oxamidebis[ethyl-3-(3,5-di-t-butyl-4-hydroxyphenyl)propionate], 2,2′-ethylidenebis(4,6-di-t-butylphenol), 2,2′-methylenebis(4-ethyl-6-t-butylphenol), 4,4′-methylenebis(2,6-di-t-butylphenol), 4,4′-butylidenebis(2-t-butyl-5-methylphenol), 4,4′-thiobis(3-methyl-6-t-butylphenol), 1,1,3-tris(2-methyl-4-hydroxy-5-t-butylphenyl)butane, bis[3,3-bis(4′-hydroxy-3′-t-butylphenyl)butanoic acid]glycol ester, 1,4-benzenedicarboxylic acid bis[2-(1,1-dimethylethyl)-6-[[3-(1,1-(dimethylethyl)-2-hydroxy-5-methylphenyl)methyl]-4-methylphenyl]]ester, 1,3,5-tris(4-t-butyl-3-hydroxy-2,6-dimethylbenzyl)isocyanurate, 2-[1-(2-hydrooxy-3,5-di-t-pentylphenyl)ethyl]-4,6-di-t-pentylphenyl acrylate, 2-t-butyl-6-(3′-t-butyl-5′-methyl-2′-hydroxybenzyl)-4-methylphenyl acrylate, 3,9-bis[2-[3-(3-t-butyl-4-hydroxy-5-methyl phenyl)propionyloxy]-1,1-dimethylethyl]-2,4,8,10-tetraoxaspiro[5,5]undecane, and the like. These phenol-based antioxidants may be used alone or in combination of two or more kinds thereof.

The product names of these phenol-based antioxidants include, for example, IRGANOX245, IRGANOX245FF, IRGANOX245DWJ, IRGANOX259, IRGANOX295, IRGANOX565, IRGANOX565DD, IRGANOX565FL, IRGANOX1010, IRGANOX1010FP, IRGANOX101OFF, IRGANOX1010DD, IRGANOX1035, IRGANOX1035FF, IRGANOX1076, IRGANOX1076FF, IRGANOX1076FD, IRGANOX1076DWJ, IRGANOX1098, IRGANOX1222, IRGANOX1330, IRGANOX1726, IRGANOX1425WL, IRGANOX3114, IRGANOX5057, IRGANOX1520L, IRGANOX1520LR, IRGANOX1135, and the like.

Among the phenol-based antioxidants, octadecyl-3-(3,5-di-t-butyl-4-hydroxyphenyl)propionate [Product Name: IRGANOX1076], pentaerythrityl-tetrakis[3-(3,5-di-t-butyl-4-hydroxyphenyl)propionate] [Product Name: IRGANOX1010], and tris-(3,5-di-t-butyl-4-hydroxybenzyl)-isocyanurate [Product Name: IRGANOX3114] are particularly preferable from the viewpoint of suppressing the resin degradation when the polyethylene-based resin particles for foaming are obtained by the extrusion process.

In particular, octadecyl-3-(3,5-di-t-butyl-4-hydroxyphenyl)propionate [Product Name: IRGANOX1076] and pentaerythrityl.tetrakis[3-(3,5-di-t-butyl-4-hydroxyphenyl)propionate] [Product Name: IRGANOX1010] are relatively inexpensive and have been widely used until now but have sometimes caused the problem of yellowing.

Meanwhile, the present invention can obtain an effect of more remarkably improving the problem of yellowing by setting the content of the phosphorus-based antioxidant in the polyethylene-based resin composition to 500 ppm or more and 1500 ppm or less and setting the antioxidant ratio to 2.0 or more and 7.5 or less. In particular, by setting the content of the phosphorus-based antioxidant in the polyethylene-based resin composition to 800 ppm or more and 1200 ppm or less and also setting the antioxidant ratio to 2.5 or more and 5.0 or less, it is possible to obtain an effect of more remarkably improving the problem of yellowing.

In the present invention, metal stearate can be blended in the polyethylene-based resin composition from the viewpoint of suppressing corrosion of an extruder and a molding machine to which the polyethylene-based resin composition is supplied and also the viewpoint of suppressing the resin degradation.

Specific examples of the metal stearate include calcium stearate, magnesium stearate, zinc stearate, and the like. The metal stearates may be used alone or in combination of two or more kinds thereof.

Among the metal stearates, calcium stearate is more preferable from the viewpoint of suppressing the resin degradation and also the viewpoint of suppressing corrosion of an extruder and a molding machine to which the polyethylene-based resin composition is supplied by effectively neutralizing a residue of a catalyst for use in polymerization of the polyethylene-based resin.

In the present invention, by blending 50 ppm or more and 20000 ppm or less of hydrophilic compounds and setting the Mz of the polyethylene-based resin foamed particles to 30×10⁴ or more and 100×10⁴ or less, a reduction in the surface layer film thickness of the polyethylene-based resin foamed particles can be further suppressed even when the metal stearate which can act as a foam nucleating agent is added.

In the present invention, the content of the metal stearate contained in the polyethylene-based resin composition is more preferably 200 ppm or more and 700 ppm or less.

By setting the content of the metal stearate to 200 ppm or more, the neutralization of the residue of the catalyst for use in polymerization of the polyethylene-based resin becomes sufficient, so that corrosion of an extruder and a molding machine to which the polyethylene-based resin composition is supplied can be suppressed.

By setting the content of the metal stearate to 700 ppm or less, a reduction in the surface layer film thickness of the polyethylene-based resin foamed particles is suppressed, so that the surface beauty of the polyethylene-based resin in-mold-foam-molded body can be made favorable.

In the present invention, an inorganic substance can be blended in the polyethylene-based resin composition in order to obtain an effect of adjusting the average cell diameter of the polyethylene-based resin foamed particles and/or an effect of uniforming the cell structures and in order to improve the foaming ratio.

In the present invention, the content of the inorganic substance contained in the polyethylene-based resin composition is preferably 100 ppm or more and 2500 ppm or less, more preferably 300 ppm or more and 2500 ppm or less, and most preferably 400 ppm or more and 2000 ppm or less.

In the present invention, by blending the 50 ppm or more and 20000 ppm or less of hydrophilic compounds and setting the Mz of the polyethylene-based resin foamed particles to 30×10⁴ or more and 100×10⁴ or less, a reduction in the surface layer film thickness of the polyethylene-based resin foamed particles can be further suppressed even when the inorganic substance which can act as a foam nucleating agent is added.

However, when the content of the inorganic substance exceeds 2500 ppm, a reduction in the surface layer film thickness of the polyethylene-based resin foamed particles tends not to be suppressed and the surface beauty of the polyethylene-based resin in-mold-foam-molded body tends to decrease.

The inorganic substance is not necessarily contained in the polyethylene-based resin composition and the content may be 0 ppm.

The inorganic substance for use in the present invention includes talc, hydrotalcite, calcium carbonate, silica, kaolin, barium sulfate, calcium hydroxide, aluminum hydroxide, aluminum oxide, titanium oxide, zeolite, zinc borate, and magnesium borate. These inorganic substances may be used alone or in combination of two or more kinds thereof.

Among the inorganic substances, talc is more preferable from the viewpoint of obtaining the effect of adjusting the average cell diameter of the polyethylene-based resin foamed particles and/or the effect of uniforming the cells and from the viewpoint of increasing the foaming ratio.

Various additives such as compatibilizing agents, antistatic agents, colorants (inorganic pigments such as carbon black, ketchen black, iron black, cadmium yellow, cadmium red, cobalt violet, cobalt blue, iron blue, ultramarine blue, chrome yellow, zinc yellow, and barium yellow; organic pigments such as perylene pigments, polyazo pigments, quinacridone pigments, phthalocyniane pigments, perinone pigments, anthraquinone pigments, thioindigo pigments, dioxazine pigments, isoindolinone pigments, and quinophthalone pigments), flame retardants, and stabilizers other than the phosphorus-based antioxidant and the phenol-based antioxidant can be used in combination without impairing the objects of the present invention.

In producing the polyethylene-based resin foamed particles of the present invention, it is preferable to first produce the polyethylene-based resin particles for foaming.

The method for producing the polyethylene-based resin particles for foaming includes a method using an extruder. A specific example of such a method includes a method including blending, in a polyethylene-based resin as a base resin, one or more compounds selected from the group consisting of antioxidants, metal stearates, and inorganic substances and a hydrophilic compound and also blending another additive, melting and kneading the obtained mixture in an extruder, extruding the resultant mixture from a die, cooling the resultant mixture, and then chopping the resultant mixture into a particle shape with a cutter.

Alternatively, a specific example also includes a method including blending a part of an additive in a polyethylene-based resin as a base resin, melting and kneading the obtained mixture in an extruder, extruding the resultant mixture from a die, cooling the resultant mixture, chopping the resultant mixture with a cutter to obtain resin pellets, blending a remaining part of the additive again in the resin pellets, placing the obtained mixture in an extruder for melting and kneading, extruding the resultant mixture from a die, cooling the resultant mixture, and then chopping the resultant mixture into a particle shape with a cutter.

An antioxidant, metal stearate, an inorganic substance, a hydrophilic compound, and another additive may be formed into a masterbatch by melting and kneading with the polyethylene-based resin beforehand, the masterbatch may be mixed with a base resin, and then the mixture may be formed into the polyethylene-based resin particles for foaming as described above.

The resin temperature of the polyethylene-based resin composition in melting and kneading in an extruder is not particularly limited and is preferably 250° C. or higher and 320° C. or less. More specifically, as a more preferable aspect of the polyethylene-based resin particles for foaming, polyethylene-based resin particles for foaming are mentioned which are obtained by performing melting and kneading at a resin temperature of 250° C. or higher and 320° C. or less in an extruder.

Since the polyethylene-based resin composition of the present invention contains a specific amount of the phosphorus-based antioxidant and the phenol-based antioxidant, no remarkable resin degradation is observed even by the extrusion at a resin temperature of 250° C. or higher and 320° C. or less and further the extrusion can be performed at a low resin viscosity. This makes it possible to reduce a load applied to the extruder even when the resin discharge amount is increased and increase the productivity per unit time of the polyethylene-based resin particles for foaming.

Even when the extrusion is performed at a resin temperature of 250° C. or higher and 320° C. or less, no remarkable resin degradation occurs and a reduction in melt index and an increase in melt tension of the polyethylene-based resin particles for foaming to be obtained can be suppressed. This makes it possible to easily increase the foaming ratio in a later foaming process.

The polyethylene-based resin foamed particles of the present invention can be produced using the polyethylene-based resin particles for foaming thus obtained.

Therefore, mentioned as a more preferable aspect of the polyethylene-based resin foamed particles are polyethylene-based resin foamed particles in which antioxidants contained in a polyethylene-based resin composition include a phosphorus-based antioxidant and a phenol-based antioxidant and which satisfy the following two conditions: (a1) the content of the phosphorus-based antioxidant contained in the polyethylene-based resin composition is 500 ppm or more and 1500 ppm or less and (a2) the ratio of the content of the phosphorus-based antioxidant to the content of the phenol-based antioxidant contained in the polyethylene-based resin composition (content of phosphorus-based antioxidant/content of phenol-based antioxidant) is 2.0 or more and 7.5 or less.

According to the polyethylene-based resin foamed particles of the present invention, even when one or more compounds selected from the group consisting of antioxidants, metal stearates, and inorganic substances contained in the polyethylene-based resin composition as a base resin are added in such a relatively large amount that the total content of the compounds is 1000 ppm or more and 4000 ppm or less, polyethylene-based resin foamed particles can be provided which are obtained by foaming polyethylene-based resin particles for foaming which have good productivity and achieve an increase in foaming ratio and in which a reduction in the surface layer film thickness and resin degradation are suppressed.

In particular, when the amount of the antioxidant is set to a specific amount in the present invention, the effect of suppressing the resin degradation of the polyethylene-based resin composition is high. Therefore, in the extrusion process of producing polyethylene-based resin particles for foaming, it is possible to produce good polyethylene-based resin particles for foaming in which the resin degradation, such as decomposition and crosslinking, is suppressed even at a high resin temperature of 250° C. or higher. Since the extrusion can be performed at a high resin temperature of 250° C. or higher, a load applied to an extruder can be reduced and the productivity (discharge amount) can be increased.

The polyethylene-based resin foamed particles of the present invention can be produced using the polyethylene-based resin particles for foaming thus obtained. A more preferable aspect of the method for producing polyethylene-based resin foamed particles includes a method for producing the same through a foaming process of dispersing the polyethylene-based resin particles for foaming together with a foaming agent in an aqueous dispersion medium in an airtight container, heating the mixture to a temperature equal to or higher than the softening temperature of the polyethylene-based resin particles for foaming, pressurizing the same, and then releasing the resultant polyethylene-based resin particles for foaming impregnated with the foaming agent into a pressure zone in which the pressure is lower than the internal pressure of the airtight container (hereinafter sometimes referred to as a “low pressure zone”, generally, atmospheric pressure). More specifically, a method for producing polyethylene-based resin foamed particles in a water dispersion system is mentioned.

Specifically, for example, the polyethylene-based resin particles for foaming, an aqueous dispersion medium, and, as needed, a dispersant and the like are placed into an airtight container. Then, as needed, the airtight container is depressurized (vacuumed). Next, a foaming agent is introduced until the pressure in the airtight container becomes 1 MPa (gage pressure) or more and 2 MPa (gage pressure) or less. Then, the mixture is heated to a temperature equal to or higher than the softening temperature of the polyethylene-based resin. The heating increases the pressure in the airtight container to a range from about 1.5 MPa (gage pressure) or more to 5 MPa (gage pressure) or less, so that the mixture is pressurized. After the heating, the foaming agent is further added as needed to adjust the foaming pressure to a desired foaming pressure. Further, the temperature is held for a period of time ranging from more than 0 min to 120 min or less while finely adjusting the temperature to the foaming temperature. Next, the polyethylene-based resin particles for foaming impregnated with the foaming agent are released into a pressure zone in which the pressure is lower than the internal pressure of the airtight container (generally, atmospheric pressure) to obtain polyethylene-based resin foamed particles.

The pressure in a collecting vessel for collecting the polyethylene-based resin foamed particles may be in the pressure range where the pressure is lower than the pressure in the airtight container and may be usually set to the atmospheric pressure by configuring a part of the collecting vessel as a system open to the atmosphere. Setting the pressure in the collecting vessel to the atmospheric pressure is preferable because there is no need for a complicated facility for controlling the pressure.

As a preferable aspect, it is also preferable that hot-water shower or steam is blown into the collecting vessel to bring the polyethylene-based resin foamed particles to be released into contact with the hot water or stream in order to increase the foaming ratio of the polyethylene-based resin foamed particles. In this case, the temperature in the collecting vessel is preferably in the range from 60° C. or higher to 120° C. or less and more preferably in the range from 90° C. or higher to 110° C. or less.

A method for introducing the foaming agent in the present invention may be a method other than the method described above. For example, the polyethylene-based resin particles for foaming, an aqueous dispersion medium, and, as needed, a dispersant and the like are placed into an airtight container, the airtight container is vacuumed as needed, and then the foaming agent may be introduced while heating the mixture to a temperature equal to or higher than the softening temperature of the polyethylene-based resin.

Alternatively, for example, the polyethylene-based resin particles for foaming, an aqueous dispersion medium, and, as needed, a dispersant and the like are placed into an airtight container, the mixture is heated up to about a foaming temperature, and then, at this point of time, the foaming agent may be introduced.

Therefore, a specific method for introducing a foaming agent into a dispersion system containing the polyethylene-based resin particles for foaming, an aqueous dispersion medium, and, as needed, a dispersant and the like is not particularly limited.

A method for adjusting the foaming ratio and the average cell diameter of the polyethylene-based resin foamed particles includes a method including pressing carbon dioxide, nitrogen, air, a substance used as the foaming agent, or the like into the airtight container before the release into the low pressure zone to thereby increase the internal pressure of the airtight container, adjusting the pressure releasing rate during foaming, and then introducing carbon dioxide, nitrogen, air, a substance used as the foaming agent, and the like into the airtight container also during the release into the low pressure zone to control the pressure. Alternatively, the foaming ratio and the average cell diameter can be adjusted by changing the temperature (approximately equal to the foaming temperature) in the airtight container as appropriate before the release into the low pressure zone.

The polyethylene-based resin foamed particles of the present invention preferably have two melting peak temperatures, i.e., a melting peak temperature on the low-temperature side and a melting peak temperature on the high-temperature side, on a DSC curve obtained from differential scanning calorimetry (DSC) as described later.

The polyethylene-based resin foamed particles having the two melting peak temperatures can be easily obtained by setting the temperature in the airtight container (approximately equal to the foaming temperature) to an appropriate temperature and also holding the temperature close to such an appropriate temperature for an appropriate period of time before the release into the low pressure zone, in the method for producing polyethylene-based resin foamed particles with an aqueous dispersion system described above.

The temperature (foaming temperature) in the airtight container before the release into the low pressure zone may be equal to or higher than the softening temperature of the polyethylene-based resin particles for foaming and is generally preferably a temperature equal to or higher than Tm−10° C., more preferably a temperature equal to or higher than Tm−5° C. and less than the melting end temperature, and still more preferably a temperature equal to or higher than Tm−5° C. and equal to or less than the melting end temperature −2° C. based on the melting point [Tm (° C.)] of the polyethylene-based resin serving as a base resin.

Herein, the melting point Tm of the polyethylene-based resin is a melting peak temperature at a second temperature increase on the DSC curve obtained by increasing the temperature of 1 mg or more and 10 mg or less of the polyethylene-based resin from 10° C. to 190° C. at a rate of 10° C./min, cooling the same to 10° C. at a rate of 10° C./min, and then increasing again the temperature to 190° C. at a rate of 10° C./min in differential scanning calorimetry (DSC) employing a differential scanning calorimeter. The melting end temperature of the polyethylene-based resin is a temperature at which the bottom of the melting peak curve obtained at the second temperature increase returns to a position of the baseline on the high-temperature side.

It is preferable that the period of time for which the polyethylene-based resin particles for foaming are held at the temperature in the airtight container (hereinafter sometimes referred to as “holding time”) is in the range from more than 0 min to 120 min or less, more preferably in the range from 2 min or more to 60 min or less, and still more preferably in the range from 10 min or more to 40 min or less.

The airtight container in which the polyethylene-based resin particles for foaming are dispersed is not particularly limited and may be one which can withstand the pressure and the temperature in the container during the production of foamed particles. A specific example of the airtight container includes an autoclave pressure-resistant container.

The foaming agent for use in the present invention includes saturated hydrocarbons such as propane, butane, and pentane, ethers such as dimethyl ether, alcohols such as methanol and ethanol, and inorganic gas such as air, nitrogen, carbon dioxide, or steam (water). The foaming agents may be used alone or in combination of two or more kinds thereof.

Among the foaming agents, carbon dioxide and steam (water) are particularly preferable and carbon dioxide is the most preferable because carbon dioxide and steam (water) have a low environmental load and have no risk of burning.

In the present invention, the foaming properties of the polyethylene-based resin particles for foaming are improved due to the fact that resin degradation during the production of the polyethylene-based resin particles for foaming is suppressed and a hydrophilic compound is blended and also the Mz of the polyethylene-based resin particles for foaming is set to about 30×10⁴ or more and 100×10⁴ or less. This makes it possible to achieve a further increased foaming ratio as compared with a former technique even by the use of carbon dioxide or steam (water), which is a foaming agent with relatively weak foaming power.

As the aqueous dispersion medium, it is preferable to use water alone but it is also possible to use a dispersion medium obtained by adding methanol, ethanol, ethylene glycol, glycerin, or the like to water. In the present invention, since a hydrophilic compound is blended in the polyethylene-based resin particles for foaming, water in the aqueous dispersion medium acts as a foaming agent and contributes to an increase in foaming ratio.

In order to prevent the agglomeration of the polyethylene-based resin particles for foaming in the aqueous dispersion medium, it is more preferable to use a dispersant. The dispersant includes inorganic dispersants such as tertiary calcium phosphate, tertiary magnesium phosphate, basic magnesium carbonate, calcium carbonate, barium sulfate, kaolin, talc, and clay.

It is preferable to use a dispersion auxiliary agent together with the dispersant. Examples of the dispersion auxiliary agent include anionic surfactants of a carboxylate type such as N-acylamino-acid salt, alkyl ether carboxylate, and acylated peptide; anionic surfactants of a sulfonate type such as alkyl sulfonate, n-paraffin sulfonate, alkyl benzene sulfonate, alkyl naphthalene sulfonate, and sulfosuccinate; anionic surfactants of a sulfuric ester type such as sulfated oil, alkyl sulfate, alkyl ether sulfate, alkyl amide sulfate, and alkyl aryl ether sulfate; and anionic surfactants of a phosphoric ester type such as alkyl phosphate and polyoxyethylene phosphate. It is also possible to use polymer surfactants of a polycarboxylic acid type such as a salt of a maleic acid copolymer and polyacrylate; and polyanionic polymer surfactants such as polystyrene sulfonate and a salt of a naphthalene sulfonate formalin condensate.

Among the substances mentioned above, it is particularly preferable to use, as the dispersant, one or more kinds selected from the group consisting of tertiary calcium phosphate, tertiary magnesium phosphate, barium sulfate, and kaolin and n-paraffin sulfonate soda as the dispersion auxiliary agent in combination.

The used amounts of the dispersant and the dispersion auxiliary agent vary according to the types thereof and the type and the amount of the polyethylene-based resin particles for foaming to be used. In usual, it is preferable to blend the dispersant in a proportion of 0.1 parts by weight or more and 3 parts by weight or less and the dispersion auxiliary agent in a proportion of 0.001 parts by weight or more and 0.1 parts by weight or less based on 100 parts by weight of the aqueous dispersion medium.

It is preferable to use the polyethylene-based resin particles for foaming in a proportion of 20 parts by weight or more and 100 parts by weight or less based on 100 parts by weight of the aqueous dispersion medium in order to achieve good dispersibility of the polyethylene-based resin particles for foaming in the aqueous dispersion medium.

As another method for producing polyethylene-based resin foamed particles using the aqueous dispersion system, it is also possible to obtain polyethylene-based resin foamed particles by, for example, impregnating polyethylene-based resin particles for foaming with the foaming agent in an aqueous dispersion system in an airtight container, cooling the resultant mixture once, taking the resultant mixture out of the airtight container to obtain non-foamed polyethylene-based resin particles, and then bringing the non-foamed polyethylene-based resin particles into contact with steam for foaming.

In the present invention, the process of obtaining polyethylene-based resin foamed particles from polyethylene-based resin particles for foaming is sometimes referred to as a “first-stage foaming process” and the polyethylene-based resin foamed particles thus obtained are sometimes referred to as “first-stage foamed particles”. Further, it is possible to obtain polyethylene-based resin foamed particles which have a further increased foaming ratio as compared with that of the first-stage foamed particles by impregnating the first-stage foamed particles with an inorganic gas such as air, nitrogen, or carbon dioxide to impart an internal pressure to the first-stage foamed particles, and then bringing the first-stage foamed particles into contact with steam of a specific pressure. In the present invention, the process of obtaining polyethylene-based resin foamed particles having a higher foaming ratio by further foaming the polyethylene-based resin foamed particles which are the first-stage foamed particles is sometimes referred to as a “second-stage foaming process” and the polyethylene-based resin foamed particles obtained through such a second-stage foaming process are sometimes referred to as “second-stage foamed particles”.

More specifically, an example of the first-stage foaming process in the present invention includes a process of producing polyethylene-based resin foamed particles by dispersing polyethylene-based resin particles for foaming containing a polyethylene-based resin composition containing 1000 ppm or more and 4000 ppm or less in total of one or more compounds selected from the group consisting of antioxidants, metal stearates, and inorganic substances and 50 ppm or more and 20000 ppm or less of hydrophilic compounds together with a foaming agent in an aqueous dispersion medium in an airtight container, heating the mixture to a temperature equal to or higher than the softening temperature of the polyethylene-based resin particles for foaming, pressurizing the same, and then releasing the resultant polyethylene-based resin particles for foaming into a pressure zone in which the pressure is lower than the internal pressure of the airtight container and the process is a preferable aspect. The second-stage foaming process in the present invention refers to a process of further foaming the polyethylene-based resin foamed particles obtained in the first-stage foaming process by placing the polyethylene-based resin foamed particles into a pressure-resistant container, impregnating the polyethylene-based resin foamed particles with an inorganic gas containing at least one kind of gas selected from the group consisting of air, nitrogen, and carbon dioxide to impart an internal pressure to the polyethylene-based resin foamed particles, and then heating the polyethylene-based resin foamed particles.

Specifically, the second-stage foaming process is a process of obtaining second-stage foamed particles having a further increased foaming ratio as compared with that of the first-stage foamed particles by impregnating the first-stage foamed particles with an inorganic gas such as air, nitrogen, or carbon dioxide to impart an internal pressure to the first-stage foamed particles, and then bringing the first-stage foamed particles into contact with steam of a specific pressure.

Herein, the pressure of the steam in the second-stage foaming process is adjusted to preferably 0.045 MPa (gage pressure) or more and 0.15 MPa (gage pressure) or less and more preferably 0.05 MPa (gage pressure) or more and 0.1 MPa (gage pressure) or less in consideration of the foaming ratio and the like of the second-stage foamed particles.

The internal pressure of the inorganic gas with which the first-stage foamed particles are impregnated is desirably changed as appropriate in consideration of the foaming ratio and the like of the second-stage foamed particles and is preferably 0.2 MPa or more (absolute pressure) and 0.6 MPa (absolute pressure) or less.

The “surface layer film” or “the film of the surface layer” in the present invention refers to a cellular film contacting the external air in cellular films constituting the cells of polyethylene-based resin foamed particles (forming the outline of the foamed particles).

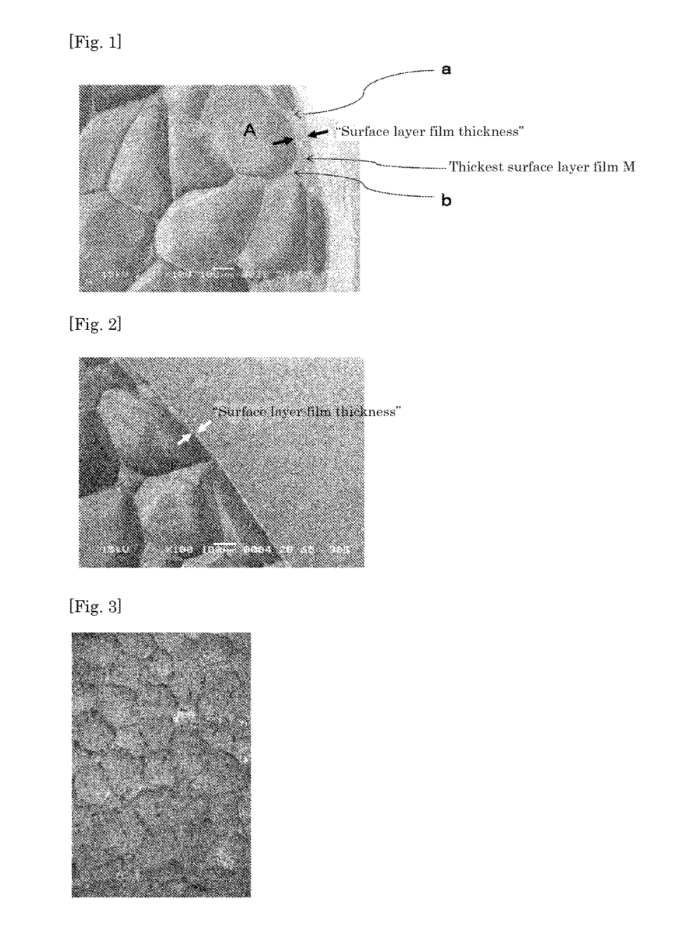

The surface layer film thickness of the polyethylene-based resin foamed particles in the present invention is defined as a value measured as follows and is described with reference to FIG. 1 which is an enlarged view of a surface layer portion of the polyethylene-based resin foamed particles according to this embodiment of the present invention of this application.

First, polyethylene-based resin foamed particles arbitrarily selected are cut substantially in the middle to be divided into almost equal two parts using a cutter, a razor, or the like. The entire circumference (surface layer of the polyethylene-based resin foamed particles) of the obtained cross section is observed with a monitor, a photograph, and the like which display the entire circumference using a microscope or a scanning electron microscope, and then one cell having the thickest surface layer film M of the thickness of the surface layer film in the entire circumference of the cross section is specified. Herein, in FIG. 1, the cell indicated by A is the cell having the thickest surface layer film M. Herein, FIG. 1 is a view observed under a scanning electron microscope.

Next, branch points a and b of the surface layer film M fixed by the specified cell A and cells adjacent to the specified cell A are determined. More specifically, in the observed cross section, the points a and b where the surface layer film M is branched to the cellular films separating the cell A and the cells adjacent to the cell A are determined.

Subsequently, the thickness of the surface layer film in the a-b section is observed with a monitor, a photograph, and the like. Then, the smallest thickness of the thickness of the surface layer film in the section is defined as the “surface layer film thickness” of the polyethylene-based resin foamed particles subjected to the measurement. More specifically, the “surface layer film thickness” of the present invention refers to the shortest distance between the surface in contact with the external air and the surface facing the surface in contact with the external air in the a-b section of the cross section. Herein, in FIG. 1, the thickness in a portion sandwiched by the thick arrows is the “surface layer film thickness”.

When the entire circumference of the cross section of the polyethylene-based resin foamed particle is observed, so that a plurality of cells considered to have the thickest surface layer film M are observed, each cell is subjected to the surface layer film thickness measurement in accordance with the description above, and then the thickest surface layer film thickness in the cells is adopted.

Furthermore, the same measurement is performed for 20 polyethylene-based resin foamed particles arbitrarily extracted, and then the average value of the surface layer film thickness of the 20 polyethylene-based resin foamed particles is defined as the surface layer film thickness of the polyethylene-based resin foamed particles in the present invention.

On the other hand, FIG. 2 is an enlarged view of a surface layer of former polyethylene-based resin foamed particles which do not relate to this embodiment, in which the surface layer film thickness of the polyethylene-based resin foamed particles in this case is a portion sandwiched by the white arrows.

The polyethylene-based resin foamed particles of the present invention have a portion where the surface layer film thickness is 11 μm or more and 120 μm or less. When the surface layer film thickness is larger, the surface properties of the in-mold-foam-molded body to be obtained become more favorable but the foaming ratio tends to become lower. From the viewpoint that the surface properties of the in-mold-foam-molded body to be obtained are favorable and polyethylene-based resin foamed particles having a high foaming ratio are obtained, the surface layer film thickness of the polyethylene-based resin foamed particles is preferably 11 μm or more and 100 μm or less and more preferably 12 μm or more and 80 μm or less.

In the present invention, the surface layer film thickness of the polyethylene-based resin foamed particles can be controlled by adjusting the content of each of the antioxidant, the metal stearate, the inorganic substance, and the hydrophilic compound within the range mentioned above. Specifically, when the content of each of the antioxidant, the metal stearate, and the inorganic substance is increased, the surface layer film thickness tends to become small, and when the content is reduced, the surface layer film thickness tends to become large.

In particular, when the content of talc is adjusted using talc as the inorganic substance, the surface layer film thickness is easily controlled. This case is a preferable aspect because it is not necessary to change the content of the antioxidant or the metal stearate and there is no influence on oxidation degradation and the like of resin.

The surface layer film thickness tends to become large also by blending a hydrophilic compound as described above. Considering the fact, it is a preferable aspect to adjust the surface layer film thickness to a desired surface layer thickness by giving the action of increasing the surface layer film thickness by blending a hydrophilic compound, and then adjusting the amount of talc.

Thus, when several experiments of systematically changing the content of each of the hydrophilic compound and talc are performed, for example, the surface layer film thickness can be easily adjusted.

The open-cell ratio of the polyethylene-based resin foamed particles of the present invention is 12% or less. When the open-cell ratio exceeds 12%, shrinkage occurs when in-mold foam molding is performed, so that the surface smoothness and the compressive strength of the polyethylene-based resin in-mold-foam-molded body tend to decrease. The open-cell ratio is more preferably 10% or less and particularly preferably 6% or less.

The polyethylene-based resin foamed particles of the present invention undergo in-mold foam molding by a method described later to be formed into a polyethylene-based resin in-mold-foam-molded body.

Since the polyethylene-based resin foamed particles of the present invention have a large surface layer film thickness, the polyethylene-based resin in-mold-foam-molded body of the present invention obtained by in-mold foam molding has a beautiful surface. Then, on the cut cross section, a pattern resulting from the surface layer portion (outline portion) of the polyethylene-based resin foamed particles is discernible. More specifically, the pattern resulting from the surface layer portion of the foamed particles on the cut cross section relates to the fact that the surface beauty of the polyethylene-based resin in-mold-foam-molded body is excellent and further shows that there is a tendency for the fusibility between the polyethylene-based resin foamed particles to be excellent.

For example, FIG. 3 shows a photograph of the cross section obtained by cutting the polyethylene-based resin in-mold-foam-molded body according to this embodiment of the present invention with a slicer, in which the outline (hexagonal pattern) of the polyethylene-based resin foamed particles constituting the polyethylene-based resin in-mold-foam-molded body can be seen and shows a characteristic pattern.

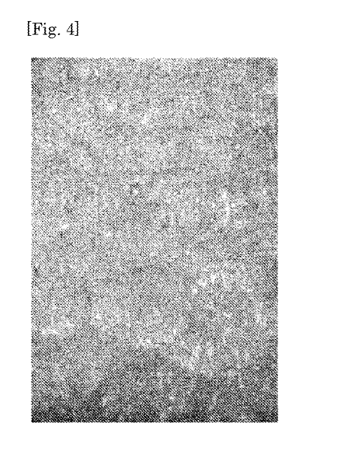

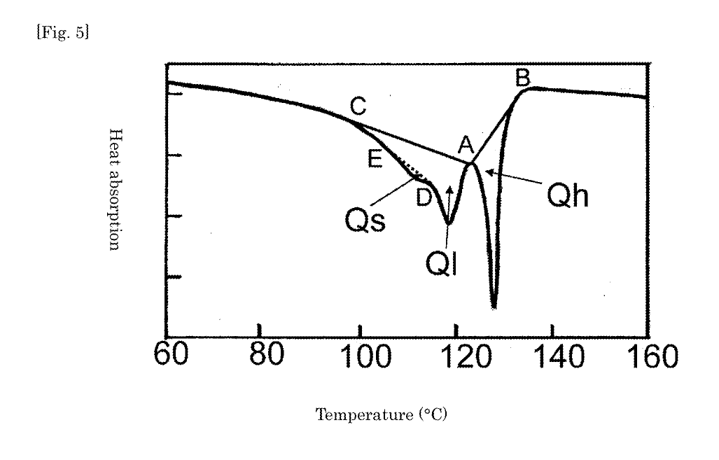

On the other hand, FIG. 4 shows a photograph of the same cross section of a former polyethylene-based resin in-mold-foam-molded body which does not relate to this embodiment, in which the outline of the polyethylene-based resin foamed particles constituting the molded body is hardly recognized.

The foaming ratio of the polyethylene-based resin foamed particles of the present invention is not particularly limited and may be adjusted as needed. However, the foaming ratio of the polyethylene-based resin foamed particles is preferably 5 times or more and 45 times or less, more preferably 10 times or more and 45 times or less, and still more preferably 20 times or more and 45 times or less from the viewpoint of a reduction in weight. In the case of such a high ratio, the effects of the present invention that the surface layer film thickness of the polyethylene-based resin foamed particles is large and the fusibility and the surface beauty are excellent are notably demonstrated.

By setting the foaming ratio of the polyethylene-based resin foamed particles to 5 times or more, the effect of reducing the weight becomes high. By setting the foaming ratio to 45 times or less, the mechanical properties, such as compressive stress, of the polyethylene-based resin in-mold-foam-molded body obtained by in-mold foam molding can be kept favorable and the surface layer film thickness can be increased to make the surface properties of the in-mold-foam-molded body favorable.

The foaming ratio of the polyethylene-based resin foamed particles refers to a value calculated by measuring the weight w (g) of the polyethylene-based resin foamed particles, immersing the polyethylene-based resin foamed particles in a measuring cylinder containing ethanol, and then measuring the volume v (cm³) based on the liquid level elevation in the measuring cylinder (immersion method). More specifically, the foaming ratio of the polyethylene-based resin foamed particles refers to a value determined by determining the absolute specific gravity ρb (=w/v) of the polyethylene-based resin foamed particles on the basis of the measurement above, and then calculating a ratio (ρr/ρb) of the density ρr (g/cm³) of the polyethylene-based resin serving as the base resin or of the polyethylene-based resin particles for foaming before foaming to the absolute specific gravity ρb.

The average cell diameter of the polyethylene-based resin foamed particles of the present invention is preferably 180 μm or more and 450 μm or less and more preferably 200 μm or more and 400 μm or less.

By setting the average cell diameter of the polyethylene-based resin foamed particles to 180 μm or more, the surface beauty of the polyethylene-based resin in-mold-foam-molded body when performing in-mold foam molding can be made favorable and by setting the average cell diameter to 450 μm or less, the buffering properties of the polyethylene-based resin in-mold-foam-molded body obtained by in-mold foam molding can be held.

The polyethylene-based resin foamed particles of the present invention preferably have two melting peak temperatures, i.e., a melting peak temperature on the low-temperature side and a melting peak temperature on the high-temperature side, on a DSC curve obtained by differential scanning calorimetry (DSC). It is more preferable that the polyethylene-based resin foamed particles have a shoulder peak in a region in which the temperature is 100° C. or higher and which is present on a lower-temperature side relative to the melting peak temperature on the low-temperature side.

Herein, the DSC curve obtained by differential scanning calorimetry of the polyethylene-based resin foamed particles refers to a DSC curve obtained by increasing the temperature of 1 mg or more and 10 mg or less of the polyethylene-based resin foamed particles from 40° C. to 190° C. at a temperature increase rate of 10° C./min using a differential scanning calorimeter.

In the present invention, the quantity of heat (Ql) of the melting peak on the low-temperature side, the quantity of heat (Qh) of the melting peak on the high-temperature side, and the quantity of heat (Qs) of the shoulder peak are defined as follows. More specifically, the point at which the quantity of heat absorption is the smallest between the two melting peaks of the melting peak on the low-temperature side and the melting peak on the high-temperature side of the DSC curve is defined as a point A and a tangent point of a tangent drawn from the point A to the DSC curve on the high-temperature side is defined as a point B and a tangent point on the low-temperature side is defined as a point C. Then, a portion surrounded by a segment AB and the DSC curve is the quantity of heat (Qh) of the melting peak on the high-temperature side and a portion surrounded by a segment AC and the DSC curve is the quantity of heat (Ql) of the melting peak on the low-temperature side. The quantity of heat (Qs) of the shoulder peak is a portion surrounded by a segment DE and the DSC curve when an inflection point corresponding to the bottom on the high-temperature side of a shoulder peak curve of the DSC curve is defined as a point D and a tangent point of a tangent drawn from the point D to the DSC curve on the low-temperature side is defined as a point E. The quantity of heat (Qs) of the shoulder peak is included in the quantity of heat (Ql) of the melting peak on the low-temperature side.

The ratio of the quantity of heat (Qs) of the shoulder peak to the quantity of heat (Ql) of the melting peak on the low-temperature side (expressed by (Qs/Ql)×100(%); hereinafter sometimes referred to as a “shoulder ratio”) on the DSC curve of the polyethylene-based resin foamed particles of the present invention is not particularly limited and is preferably 0.2% or more and 3% or less and more preferably 0.2% or more and 1.6% or less.

By setting the shoulder ratio to 0.2% or more, the fusion level at end portions (edge portion) and the appearance of the polyethylene-based resin in-mold-foam-molded body to be obtained increase and the surface smoothness of the polyethylene-based resin in-mold-foam-molded body also becomes favorable.

Meanwhile, by setting the shoulder ratio to 3% or less, the occurrence of blocking due to the agglomeration of the polyethylene-based resin foamed particles is effectively suppressed, and thus the polyethylene-based resin foamed particles can be subjected to the subsequent in-mold foam molding.

Such polyethylene-based resin foamed particles having a shoulder peak on a DSC curve can be obtained by, for example, a method including the second-stage foaming process. Specifically, in order to develop the shoulder peak on a DSC curve, the pressure of the steam in the second-stage foaming process is preferably adjusted to 0.045 MPa (gage pressure) or more and 0.15 MPa (gage pressure) or less and more preferably 0.05 MPa (gage pressure) or more and 0.1 MPa (gage pressure) or less. The shoulder peak ratio tends to be higher as the pressure of the steam in the second-stage foaming process becomes larger. Further, in this case, it is desirable to change, as appropriate, the internal pressure of the inorganic gas with which the first-stage foamed particles are impregnated in consideration of the foaming ratio and the like of the second-stage foamed particles. The internal pressure of the inorganic gas is preferably 0.2 MPa (absolute pressure) or more and 0.6 MPa (absolute pressure) or less.

The ratio of the quantity of heat (Qh) of the melting peak on the high-temperature side to the entire melting quantity of heat [expressed by Qh/(Ql+Qh)×100; hereinafter sometimes referred to as a “DSC ratio”] is not particularly limited and is preferably 20% or more and 55% or less.

By setting the DSC ratio to 20% or more, the foaming power of the polyethylene-based resin foamed particles can be moderately adjusted, so that a phenomenon in which only the polyethylene-based resin foamed particles in the vicinity of a mold surface (a surface layer portion of the polyethylene-based resin in-mold-foam-molded body) are explosively foamed and the foamed particles are fused with each other at an initial stage of in-mold foam molding can be efficiently suppressed. Consequently, steam for use in the in-mold foam molding infiltrates into the polyethylene-based resin foamed particles located in an inner portion of the mold, and therefore a polyethylene-based resin in-mold-foam-molded body in which fusion occurs to the inner portion of the foam-molded body can be obtained.

By setting the DSC ratio to 55% or less, the foaming power of the polyethylene-based resin foamed particles can be increased and the entire polyethylene-based resin in-mold-foam-molded body can be fused at a suitable molding pressure.

The DSC ratio can be adjusted by changing, as appropriate, the temperature in the airtight container before the release into the above-described low pressure zone and the holding time in obtaining the polyethylene-based resin foamed particles. In general, the DSC ratio tends to become larger as the temperature (foaming temperature) in the airtight container becomes lower. Further, the DSC ratio tends to become larger as the holding time becomes longer. Accordingly, several experiments in which the temperature in the airtight container and the holding time are varied make it possible to find out the conditions for obtaining an approximately desired DSC ratio.

According to the method for producing polyethylene-based resin foamed particles of the present invention, it is possible to produce polyethylene-based resin foamed particles in which a reduction in the surface layer film thickness and resin degradation are suppressed even in a case where carbon dioxide which is a foaming agent with relatively weak foaming power is used and relatively large amounts of a phosphorus-based antioxidant and a phenol-based antioxidant are contained. Moreover, the polyethylene-based resin foamed particles to be obtained achieve an increase in foaming ratio.

The polyethylene-based resin foamed particles thus obtained can be molded into a polyethylene-based resin in-mold-foam-molded body by performing known in-mold foam molding.

A specific method for molding the polyethylene-based resin in-mold-foam-molded body by performing known in-mold foam molding is not particularly limited and includes, for example,

(I) a method including subjecting the polyethylene-based resin foamed particles to pressurization treatment with an inorganic gas such as air, nitrogen, or carbon dioxide, impregnating the polyethylene-based resin foamed particles with the inorganic gas to impart a predetermined internal pressure to the polyethylene-based resin foamed particles, filling a mold with the polyethylene-based resin foamed particles, and then thermally fusing the polyethylene-based resin foamed particles by steam;

(II) a method including filling a mold with the polyethylene-based resin foamed particles by compressing the polyethylene-based resin foamed particles with pressure of an inorganic gas, and then thermally fusing the polyethylene-based resin foamed particles by steam utilizing the resilience of the polyethylene-based resin foamed particles; and

(III) a method including filling a mold with the polyethylene-based resin foamed particles without particular pretreatment, and then thermally fusing the polyethylene-based resin foamed particles by steam.

The molding conditions, such as a molding pressure, in the in-mold foam molding are not particularly limited, and the molding can be performed under known conditions with appropriate adjustment.

The density of the polyethylene-based resin in-mold-foam-molded body in the present invention may be set as appropriate in accordance with the foaming ratio of the polyethylene-based resin foamed particles, a strength required for the polyethylene-based resin in-mold-foam-molded body, or the like and is generally preferably in the range from 10 g/L or more to 300 g/L or less and more preferably in the range from 14 g/L or more to 100 g/L or less. From the viewpoint of sufficient development of the buffering properties which are excellent properties of the polyethylene-based resin in-mold-foam-molded body, the density is still more preferably in the range from 16 g/L or more to 50 g/L or less.

The polyethylene-based resin in-mold-foam-molded body obtained by in-mold foam molding the polyethylene-based resin foamed particles is reduced in yellowing of the molded body surface occurring during the in-mold foam molding and is excellent in surface beauty. Therefore, the polyethylene-based resin foamed particles of the present invention can provide a polyethylene-based resin in-mold-foam-molded body which is reduced in yellowing of the molded body surface occurring during the in-mold foam molding and is excellent in surface beauty.

### EXAMPLES

Hereinafter, the present invention is more specifically described with reference to Examples and Comparative Examples but the present invention is not limited only to Examples. The technical contents described in each Example can be used in combination with the technical contents described in other Examples as appropriate.

Table 1 shows the physical properties of each of polyethylene-based resins (A-1, A-2, A-3, B-1, B-2, B-3, B-4) which is a base resin used in Production Examples, Examples, and Comparative Examples.

TABLE 1

| Polyethylene-based | | Melting | | |
|---|---|---|---|---|
| resin | Mz | point | Density | Melt Index |
| Linear low density | 40 × 10⁴ | 122° C. | 0.93 g/cm³ | 1.8 g/10 min |
| polyethylene-based | | | | |
| resin A-1 | | | | |
| Linear low density | 49 × 10⁴ | 122° C. | 0.93 g/cm³ | 1.8 g/10 min |
| polyethylene-based | | | | |
| resin A-2 | | | | |
| Linear low density | 68 × 10⁴ | 122° C. | 0.93 g/cm³ | 1.8 g/10 min |
| polyethylene-based | | | | |
| resin A-3 | | | | |
| Linear low density | 35 × 10⁴ | 122° C. | 0.93 g/cm³ | 1.9 g/10 min |
| polyethylene-based | | | | |
| resin B-1 | | | | |
| Linear low density | 77 × 10⁴ | 122° C. | 0.93 g/cm³ | 1.8 g/10 min |
| polyethylene-based | | | | |
| resin B-2 | | | | |
| Linear low density | 28 × 10⁴ | 122° C. | 0.93 g/cm³ | 4.5 g/10 min |
| polyethylene-based | | | | |
| resin B-3 | | | | |
| Linear low density | 105 × 10⁴ | 122° C. | 0.93 g/cm³ | 1.3 g/10 min |
| polyethylene-based | | | | |
| resin B-4 | | | | |

Raw materials other than the polyethylene-based resin used in Production Examples, Examples, and Comparative Examples are as follows.

1) Phosphorus-based antioxidant:

Tris(2,4-di-t-butylphenyl)phosphite [manufactured by BASF A.G., Product Name: IRGAFOS168]

2) Phenol-based antioxidant:

Octadecyl-3-(3,5-di-t-butyl-4-hydroxyphenyl)propionate [manufactured by BASF A.G., Product Name: IRGANOX1076]

Pentaerythrityl.tetrakis[3-(3,5-di-t-butyl-4-hydroxyphenyl)propionate [manufactured by BASF A.G., Product Name: IRGANOX1010]

Metal stearate:

Calcium stearate [manufactured by NOF Corporation, calcium stearate]

3) Inorganic substance:

Talc [manufactured by Hayashi Kasei Co., Ltd., Talcan powder (Registered Trademark) PK-S]

4) Hydrophilic compound:

Glycerin [manufactured by Lion Corporation, Refined glycerin D]

Polyethylene glycol [manufactured by SANYOKASEI Co., Ltd., PEG-300, molecular weight of 300]

Polyethylene glycol [manufactured by SANYOKASEI Co., Ltd., PEG-6000P, molecular weight of 6000]

Melamine [manufactured by Nissan Chemical Industries, Ltd., melamine]

Evaluations in Examples and Comparative Examples were carried out by the following methods.

### <Surface Layer Film Thickness of Polyethylene-Based Resin Foamed Particles>

The surface layer film thickness of the polyethylene-based resin foamed particles in the present invention is defined as a value measured as follows and is described with reference to FIG. 1 which is an enlarged view of a surface layer portion of the polyethylene-based resin foamed particles of the present invention of this application.

First, polyethylene-based resin foamed particles arbitrarily selected are cut substantially in the middle to be divided into almost equal two parts using a cutter, a razor, or the like. The entire circumference (surface layer of the polyethylene-based resin foamed particles) of the obtained cross section is observed with a monitor, a photograph, and the like which display the entire circumference using a microscope or a scanning electron microscope, and then one cell having the thickest surface layer film M of the thickness of the surface layer film in the entire circumference of the cross section is specified. Herein, in FIG. 1, the cell indicated by A is the cell having the thickest surface layer film M. Herein, FIG. 1 is a view observed under a scanning electron microscope.

Next, branch points a and b of the surface layer film M fixed by the specified cell A and cells adjacent to the specified cell A are determined. More specifically, in the observed cross section, the points a and b where the surface layer film M is branched to the cellular films separating the cell A and the cells adjacent to the cell A are determined.

Subsequently, the thickness of the surface layer film in an a-b section is observed with a monitor, a photograph, and the like. Then, the smallest thickness of the thickness of the surface layer film in the section is defined as the “surface layer film thickness” of the polyethylene-based resin foamed particles subjected to the measurement. More specifically, the “surface layer film thickness” of the present invention refers to the shortest distance between the surface in contact with the external air and the surface facing the surface in contact with the external air in the a-b section of the cross section. Herein, in FIG. 1, the thickness in a portion sandwiched by the thick arrows is the “surface layer film thickness”.

When the entire circumference of the cross section of the polyethylene-based resin foamed particle is observed, so that a plurality of cells considered to have the thickest surface layer film M are observed, each cell is subjected to the surface layer film thickness measurement in accordance with the description above, and then the thickest surface layer film thickness in the cells is adopted.

Furthermore, the same measurement is carried out for 20 polyethylene-based resin foamed particles arbitrarily extracted, and then the average value of the surface layer film thickness of the 20 polyethylene-based resin foamed particles is defined as the surface layer film thickness of the polyethylene-based resin foamed particles in the present invention.

### <Mz Measurement Method>

Adopted as the Z-average molecular weight (Mz; converted in terms of polystylene) of a polyethylene-based resin which serves as a base resin, polyethylene-based resin particles for foaming, or polyethylene-based resin foamed particles was Mz obtained under the following measurement conditions by gel permeation chromatography (GPC).

### (Measurement Conditions)

Pretreatment of sample: 7 mg of a sample was precisely weighed, and then completely dissolved in 9 mL of o-dichlorobenzene (containing 1 g/L of BHT (dibutyl hydroxytoluene)) at 140° C. Then, the solution was filtered to be used as a sample to be analyzed.
Measurement device: GPCV 2000 system (manufactured by Waters Alliance)
Column: 1 column of Shodex (Registered Trademark, which similarly applies to the following description) UT-G, 2 columns of Shodex UT-806M, 1 column of Shodex UT-807 (all manufactured by Showa Denko K.K.)

### Column Temperature: 140° C.

Eluate o-dichlorobenzene (containing 1 g/L of BHT) for high performance liquid chromatograph
Eluate flow amount: 1.0 mL/min
Sample concentration: about 0.8 mg/mL
Sample solution filtration: membrane filter having a pore diameter of 0.5 μm manufactured by PTFE

### Injection Amount: 317 μL

### Analysis Time: 50 min

Analysis software: Empower (Registered Trademark) GPC/V (manufactured by Waters Alliance)
Detector: differential refractive index detector (RI)
Used standard sample (10 types in total): standard polystylene (Shodex Standard)
Molecular weight . . . 7.30×10⁶, 3.85×10⁶, 2.06×10⁶, 7.36×10⁵, 1.97×10⁵, 2.20×10⁴, 1.28×10⁴, 7.20×10³, 3.95×10³ (9 types): polystylene A-300 (Shodex)
Molecular weight . . . 3.70×10² (1 type)

### <Melt Index (MI) of Polyethylene-Based Resin and the Like>

The melt index (MI) of the polyethylene-based resin or the polyethylene-based resin particles for foaming was measured at a temperature of 190° C. and a load of 2.16 kg in accordance with JIS K7210.

### <Melt Tension (MT) of Polyethylene-Based Resin Particles for Foaming>

The melt tension (MT) of the polyethylene-based resin particles for foaming was measured under the following conditions using CAPILOGRAPH 1D manufactured by Toyo Seiki Seisaku-sho, Ltd.

Measurement temperature: 190° C.
Barrel internal diameter: 9.55 mm
Capillary: 2.095 mm (D)×8.02 mm (L), inflow angle of 60°
Piston extrusion speed: 10 mm/min
Take-up speed: 78.5 m/min (corresponding to the number of rotations of a 50 mmφ roller of 500 rpm)
Contact point distance between capillary tip and pulley for measurement of melt tension: 53 cm

Although the melt tension has amplitude on a chart, a medium value of the amplitude is used as the melt tension in the present invention.

### <DSC Measurement of Polyethylene-Based Resin Foamed Particles>

The melting peak temperatures (melting peak temperature on the low-temperature side and melting peak temperature on the high-temperature side), the DSC ratio, the shoulder peak ratio, or the melting heat quantity was calculated from a DSC curve obtained by differential scanning calorimetry (DSC) in the first temperature increase obtained when increasing the temperature of 3 mg to 6 mg of polyethylene-based resin foamed particles from 40° C. to 190° C. at a temperature increase rate of 10° C./min using a differential scanning calorimeter (manufactured by Seiko Instruments Inc., DSC6200).

### <Foaming Ratio>

3 g or more and 10 g or less of polyethylene-based resin foamed particles were weighed, and then dried at 60° C. for 6 hours. Then, the state of the polyethylene-based resin foamed particles was adjusted to a temperature of 23° C. and a humidity of 50% in a room. Subsequently, the weight w (g) of the polyethylene-based resin foamed particles was measured, the polyethylene-based resin foamed particles were immersed in a measuring cylinder containing ethanol, and then the volume v (cm³) of the polyethylene-based resin foamed particles was measured based on the liquid level elevation in the measuring cylinder (immersion method). Then, the absolute specific gravity ρb (=w/v) of the polyethylene-based resin foamed particles was obtained from the volume v (cm³), and the ratio (ρr/ρb) of the density ρr (g/cm³) of the polyethylene-based resin particles for foaming to the absolute specific gravity ρb was defined as a foaming ratio K (=ρr/ρb). In Examples and Comparative Examples described below, the density pr of the polyethylene-based resin particles for foaming was the same as the density of the used polyethylene-based resin in every case.

### <Average Cell Diameter>

The polyethylene-based resin foamed particles were cut substantially in the middle so as not to break a cell membrane (cell membrane of the polyethylene-based resin foamed particles) using a cutter and each of the cross-sections was observed under a microscope [manufactured by KEYENCE Corporation, digital microscope VHX-100]. Then, a segment equivalent to a length of 1000 μm was drawn on a portion other than a surface layer portion of the polyethylene-based resin foamed particles, and the number of cells n present on the segment was measured. Then, the cell diameter was calculated from the number of cells n according to 1000/n (μm). Similar measurement was carried out for 10 polyethylene-based resin foamed particles, and the average value of cell diameters calculated for each of the polyethylene-based resin foamed particles was determined as an average cell diameter.

### <Open-Cell Ratio>

The open-cell ratio (%) was determined in accordance with the following equation, in which the volume of the polyethylene-based resin foamed particles obtained in accordance with a method described in a PROSEDURE C of ASTM D2856-87 is Vc (cm³):

Open−cell ratio(%)=((Va−Vc)×100)/Va.

The Vc was measured using an air-comparison pycnometer Model 1000 manufactured by Tokyoscience Co., Ltd. The volume Va (cm³) is an apparent volume of the polyethylene-based resin foamed particles determined based on the liquid level elevation in the measuring cylinder (immersion method) by immersing the entire amount of the polyethylene-based resin foamed particles after measuring the Vc by the air-comparison pycnometer in a measuring cylinder containing ethanol.

<Fusibility of Polyethylene-Based Resin in-Mold-Foam-Molded Body>

In-mold foam molding was carried out using a mold for producing a polyethylene-based resin in-mold-foam-molded body having a designed dimension of 400 mm×300 mm×50 mm without imparting an internal pressure to the polyethylene-based resin foamed particles to be filled into the mold while changing the molding pressure in the range from 0.08 MPa (gage pressure) to 0.14 MPa (gage pressure) by increments of 0.01 MPa. The obtained foam-molded body was allowed to stand at 23° C. for 2 hours, cured at 65° C. for 24 hours, and then left to stand in a 23° C. room for 4 hours to be used as an evaluation target.

A crack having a depth of about 5 mm was formed with a knife in the surface of the polyethylene-based resin in-mold-foam-molded body to be evaluated, and then the polyethylene-based resin in-mold-foam-molded body was split along the crack. Then, the broken-out sections were observed. The ratio of broken particles to all the particles on the broken-out section was determined to be used as a molded body fusion ratio (%).

The minimum molding pressure (gage pressure) at which the molded body fusion ratio reaches 70% or more was used as an index of fusibility.

<Evaluation of Yellowing of Polyethylene-Based Resin in-Mold-Foam-Molded Body>

Immediately after performing in-mold foam molding at a molding pressure of 0.11 MPa (gage pressure) using the mold used for the measurement of the fusibility without imparting an internal pressure to the polyethylene-based resin foamed particles to be filled into the mold, the surface of the obtained polyethylene-based resin in-mold-foam-molded body was visually observed, and then the yellowing was evaluated according to the following criteria:

◯: No yellowing was observed;
Δ: Slight yellowing was observed; and
x: Yellowing was clearly observed.
<Surface Beauty of Polyethylene-Based Resin in-Mold-Foam-Molded Body>

In-mold foam molding was carried out at a molding pressure of 0.11 MPa (gage pressure) using the mold used for the measurement of the fusibility without imparting an internal pressure to the polyethylene-based resin foamed particles to be filled into the mold.

The obtained polyethylene-based resin in-mold-foam-molded body was allowed to stand at 23° C. for 2 hours, cured at 65° C. for 24 hours, and then left to stand in a 23° C. room for 4 hours. Thereafter, the surface (surface opposite to the surface which was charged with the polyethylene-based resin foamed particles among 400 mm×300 mm surfaces) of the polyethylene-based resin in-mold-foam-molded body was visually observed, the number of dents observed between the polyethylene-based resin foamed particles was counted, and then the surface beauty was evaluated according to the following criteria:

⊚: The number of dents between the polyethylene-based resin foamed particles is less than 70;
◯: The number of dents between the polyethylene-based resin foamed particles is 70 or more and less than 200;
Δ: The number of dents between the polyethylene-based resin foamed particles is 200 or more and less than 500; and
x: The number of dents between the polyethylene-based resin foamed particles is 500 or more.

When shrinkage was observed in the polyethylene-based resin in-mold-foam-molded body, the fact is mentioned in the remarks column of Table 3-1, Table 3-2, and Table 3-3, or Table 4 showing the results.

<Pattern of Cut Cross Section of Polyethylene-Based Resin in-Mold-Foam-Molded Body>

In-mold foam molding was carried out at a molding pressure of 0.11 MPa (gage pressure) using the mold used for the measurement of the fusibility without imparting an internal pressure to the polyethylene-based resin foamed particles to be filled into the mold. The obtained polyethylene-based resin in-mold-foam-molded body was allowed to stand at 23° C. for 2 hours, cured at 65° C. for 24 hours, and then left to stand in a 23° C. room for 4 hours.

Subsequently, the polyethylene-based resin in-mold-foam-molded body was cut using a band saw [manufactured by LUXO, U-32] in such a manner that the thickness of 50 mm was half to be formed into a polyethylene-based resin in-mold-foam-molded body of 400 mm×300 mm×25 mm.

The cut cross section was visually observed, and then evaluated according to the following criteria:

◯: The outline of the polyethylene-based resin foamed particles constituting the polyethylene-based resin in-mold-foam-molded body can be seen and shows a characteristic hexagonal pattern-like pattern; and
x: The outline of the polyethylene-based resin foamed particles constituting the polyethylene-based resin in-mold-foam-molded body is not clear and also the characteristic pattern is not clear.

### Production of Polyethylene-Based Resin Particles for Foaming

### Production Examples 1 to 10

To 20 kg of a linear low density polyethylene-based resin, a phosphorus-based antioxidant, a phenol-based antioxidant, metal stearate, an inorganic substance, and another additive were blended in such a manner as to have blended amounts shown in Table 2. The obtained blended substance was placed in a 45 mmφ twin-screw extruder (manufactured by O. N. MACHINERY Co., Ltd., TEK45), and was melted and kneaded under the extrusion conditions shown in Table 2. Thereafter, the kneaded substance was extruded from a cylindrical die having a diameter of 1.8 mm connected to the tip of the extruder, cooled with water, and then cut with a cutter to obtain cylindrical polyethylene-based resin particles for foaming (1.3 mg/particle).

As the resin temperature, a value measured by a resin thermometer attached to a die connected next to the tip of the screws of the twin-screw extruder was read.

The obtained polyethylene-based resin particles for foaming were evaluated for the melt index, melt tension, and Mz. The results are shown in Table 2.

TABLE 2

| | | | Production Example | | | | | | | | | |
|---|---|---|---|---|---|---|---|---|---|---|---|---|
| | | | 1 | 2 | 3 | 4 | 5 | 6 | 7 | 8 | 9 | 10 |
| Polyethylene-based resin | | — | A-2 | A-2 | A-2 | A-2 | A-2 | A-2 | A-2 | A-2 | A-2 | B-2 |
| Phosphorus-based | IRGAFOS168 | ppm | 450 | 450 | 450 | 1000 | 1000 | 1000 | 1000 | 1000 | 750 | 1000 |
| antioxidant | | | | | | | | | | | | |
| Phenol-based | IRGANOX1076 | ppm | 300 | 300 | 300 | 300 | 300 | 300 | 300 | | | 300 |
| antioxidant | IRGANOX1010 | ppm | | | | | | | | 300 | 250 | |
| Antioxidant ratio | | — | 1.5 | 1.5 | 1.5 | 3.3 | 3.3 | 3.3 | 3.3 | 3.3 | 3.0 | 3.3 |
| Total amount of antioxidant | | ppm | 750 | 750 | 750 | 1300 | 1300 | 1300 | 1300 | 1300 | 1000 | 1300 |
| Metal stearate | Calcium stearate | ppm | 400 | 400 | 400 | 400 | 400 | 400 | 400 | 400 | 400 | 400 |
| Inorganic | Talc | ppm | 300 | 300 | 300 | 300 | 300 | 300 | 300 | 300 | 1000 | 300 |
| substance | | | | | | | | | | | | |
| Total amount of antioxidant + metal | | ppm | 1450 | 1450 | 1450 | 2000 | 2000 | 2000 | 2000 | 2000 | 2400 | 2000 |
| stearate + inorganic substance | | | | | | | | | | | | |
| Another | Glycerin | ppm | 2000 | 2000 | 2000 | 2000 | 2000 | 2000 | 2000 | 2000 | 2000 | 2000 |
| additive | | | | | | | | | | | | |
| Extrusion | Number of rotations | rpm | 50 | 50 | 50 | 50 | 50 | 50 | 50 | 50 | 50 | 50 |
| conditions | of screws | | | | | | | | | | | |
| | Discharge amount | kg/h | 20 | 30 | 20 | 20 | 30 | 20 | 30 | 20 | 20 | 20 |
| | Resin temperature | ° C. | 210 | 210 | 290 | 210 | 210 | 290 | 290 | 290 | 290 | 210 |
| | Load to extruder | Ampere | 90 | 105 | 70 | 90 | 105 | 65 | 75 | 65 | 65 | 93 |
| Polyethylene- | Melt Index | g/10 min | 1.8 | 1.8 | 1.3 | 1.8 | 1.8 | 1.8 | 1.8 | 1.8 | 1.7 | 1.8 |
| based resin | Melt Tension | g | 1.4 | 1.4 | 3.0 | 1.4 | 1.4 | 1.4 | 1.4 | 1.4 | 1.9 | 1.4 |
| particles for | Mz (×10⁻⁴)(Note) | — | 50 | 50 | 51 | 50 | 50 | 50 | 50 | 50 | 50 | 78 |
| foaming | Resin particle No. | | P-1 | — | P-2 | P-3 | — | P-4 | P-5 | P-6 | P-7 | P-8 |

(Note):
In the column of Mz, values obtained by multiplying Mz by 10⁻⁴ are indicated.

A comparison between Production Example 1 and Production Example 2 or a comparison between Production Example 4 and Production Example 5 shows that an increase in the discharge amount of the kneaded substance from 20 kg/hour to 30 kg/hour leads to an increase in a load (value obtained by reading a current value required for rotating the screws of the extruder from a current value display of an extruder control panel) to the extruder.

A comparison between Production Example 1 and Production Example 3 shows that, when the antioxidant ratio is 1.5, an increase in the resin temperature from 210° C. to 290° C. leads to a reduction in the load to the extruder but leads to a reduction in the melt index and an increase in the melt tension of the polyethylene-based resin particles for foaming to be obtained. This is assumed to be because, when the resin temperature was set to 290° C., the polyethylene-based resin was decomposed and cross-linked in the extruder to cause resin degradation.

A comparison between Production Example 4 and Production Example 6 shows that, when the antioxidant ratio is 3.3, an increase in the resin temperature from 210° C. to 290° C. leads to a reduction in the load to the extruder but causes no change in the melt index and the melt tension of the polyethylene-based resin particles for foaming to be obtained. This is assumed to be because, by setting the antioxidant ratio to 3.3, resin degradation of the polyethylene-based resin was suppressed even when the resin temperature was 290° C.

A comparison between Production Example 4 and Production Example 7 shows that, when the antioxidant ratio is 3.3, an increase in the resin temperature from 210° C. to 290° C. makes it possible to increase the discharge amount of the kneaded substance without extremely increasing the load to the extruder and to suppress degradation of the polyethylene-based resin.

A comparison between Production Example 8 and Production Example 9 shows that, when the total content of the phosphorus-based antioxidant and the phenol-based antioxidant is less than 1100 ppm, in the case where the polyethylene-based resin particles for foaming are obtained at a high resin temperature of 290° C., the melt index slightly decreases and the melt tension slightly increases. It is considered from the fact that slight degradation of the polyethylene-based resin occurred.

### Example 1

### Production of Polyethylene-Based Resin Foamed Particles

Into a pressure-resistant airtight container, 100 parts by weight of the polyethylene-based resin particles for foaming (P-1) obtained in Production Example 1 were placed together with 200 parts by weight of pure water, 0.5 parts by weight of tertiary calcium phosphate, and 0.05 parts by weight of n-paraffin sulfonate soda. After deaerating, 7.5 parts by weight of carbon dioxide were put into the pressure-resistant airtight container under stirring and then heated in such a manner that the temperature reached 122° C. The pressure (foaming pressure) in the pressure-resistant airtight container when the temperature in the pressure-resistant airtight container reached 122° C. was 3.4 MPa (gage pressure). After the temperature in the pressure-resistant airtight container reached 122° C., the pressure-resistant airtight container was held for 25 min, and then a water dispersion (foamed particles and an aqueous dispersion medium) was released into a foaming cylinder under atmospheric pressure through an orifice by opening a valve provided in a lower part of the airtight container to thereby obtain foamed particles (first-stage foamed particles). In the process, carbon dioxide was additionally pressed into the pressure-resistant airtight container in such a manner that the pressure in the pressure-resistant airtight container did not decrease during the release of the water dispersion, and thus the pressure was held. Separately, steam was blown into the foaming cylinder to warm the foaming cylinder to 100° C., so that the foamed particles to be released and the steam were brought into contact with each other.

The obtained first-stage foamed particles exhibited two melting points of 117° C. and 128° C. in differential scanning calorimetry and a DSC ratio of 30% and did not exhibit a shoulder peak. The first-stage foamed particles had a foaming ratio of 11 times, a surface layer film thickness of 30 μm, an average cell diameter of 130 μm, and an open-cell ratio of 2%.

Subsequently, the obtained first-stage foamed particles were subjected to second-stage foaming by drying the particles at 60° C. for 6 hours, setting the internal pressure to 0.57 MPa (absolute pressure) by impregnating the particles with pressurized air in the pressure-resistant container, and then bringing the particles into contact with steam having a steam pressure of about 0.06 MPa (gage pressure).

The obtained second-stage foamed particles exhibited two melting points of 118° C. and 128° C. in differential scanning calorimetry, a DSC ratio of 40%, a shoulder peak ratio of 0.3%, and an Mz of 50×10⁴. The second-stage foamed particles had a foaming ratio of 26 times, a surface layer film thickness of 23 μm, an average cell diameter of 250 μm, and an open-cell ratio of 5%.

<Production of Polyethylene-Based Resin in-Mold-Foam-Molded Body>

The obtained second-stage foamed particles were in-mold foam molded by filling the particles into a mold of 400 mm×300 mm×50 mm without imparting an internal pressure to the particles. The in-mold foam molding was carried out at the molding pressure in the range from 0.08 MPa (gage pressure) to 0.14 MPa (gage pressure) by increments of 0.01 MPa. At all the molding pressures, the period of time of each of discharge/one-side heating/other-side heating/two-side heating was 3/7/7/10 sec. The obtained polyethylene-based resin in-mold-foam-molded body was evaluated for fusibility, yellowing, and surface smoothness. The results are shown in Table 3-1.

### Examples 2 to 6

Polyethylene-based resin foamed particles and a polyethylene-based resin in-mold-foam-molded body were obtained in the same manner as in Example 1, except using the polyethylene-based resin particles for foaming (P-3) to (P-7) shown in Table 3-1 obtained in Production Examples in place of the polyethylene-based resin particles for foaming (P-1).

The results are shown in Table 3-1.

### Examples 7 to 20, Comparative Examples 1 to 5

### Production of Polyethylene-Based Resin Particles for Foaming

Polyethylene-based resin particles for foaming were obtained in the same manner as in Production Example 1, except using a linear low density polyethylene-based resin, a phosphorus-based antioxidant, a phenol-based antioxidant, metal stearate, an inorganic substance, and a hydrophilic compound in such a manner as to have compositions and amounts shown in Table 3-2, Table 3-3, or Table 4. When the resin particle number is given, polyethylene-based resin particles for foaming were obtained in accordance with the corresponding Production Examples.

[Production of Polyethylene-Based Resin Foamed Particles] and [Production of Polyethylene-Based Resin in-Mold-Foam-Molded Body]

Polyethylene-based resin foamed particles and a polyethylene-based resin in-mold-foam-molded body were obtained in the same manner as in Example 1, except using the obtained polyethylene-based resin particles for foaming.

The results are shown in Table 3-1, Table 3-2, Table 3-3, and Table 4.

In Example 11, the obtained first-stage foamed particles were subjected to in-mold foam molding. In Comparative Example 5, the kneaded substance was placed in the extruder, and then extruded from the cylindrical die in order to obtain polyethylene-based resin particles for foaming but an extruded strand was frequently cut and stable extrusion was not able to be carried out, and therefore the experiment was stopped.

### Comparative Example 6

### Production of Polyethylene-Based Resin Particles for Foaming

Polyethylene-based resin particles for foaming were obtained in the same manner as in Production Example 1, except using a linear low density polyethylene-based resin, a phosphorus-based antioxidant, a phenol-based antioxidant, metal stearate, and an inorganic substance in such a manner as to have compositions and amounts shown in Table 4.

### [Production of Polyethylene-Based Resin Foamed Particles]

Into a pressure-resistant airtight container, 100 parts by weight of the obtained polyethylene-based resin particles for foaming were placed together with 300 parts by weight of pure water, 2 parts by weight of tertiary calcium phosphate, and 0.001 parts by weight of n-paraffin sulfonate soda. After deaerating, 19 parts by weight of isobutane was placed into the pressure-resistant airtight container under stirring, and then heated in such a manner that the temperature reached 114° C. After the temperature in the pressure-resistant airtight container reached 114° C., isobutane was further pressed into the pressure-resistant airtight container to set the pressure (foaming pressure) in the pressure-resistant airtight container to 1.8 MPa (gauge pressure), and then the pressure-resistant airtight container was held for 10 min. Then, a water dispersion (foamed particles and an aqueous dispersion medium) was released into a foaming cylinder under atmospheric pressure through an orifice by opening a valve provided in a lower part of the airtight container to thereby obtain foamed particles (first-stage foamed particles). In the process, nitrogen was additionally pressed into the pressure-resistant airtight container in such a manner that the pressure in the pressure-resistant airtight container did not decrease during the release of the water dispersion, and thus the pressure was held. Separately, steam was blown into the foaming cylinder to warm the same, so that the foamed particles to be released and the steam were brought into contact with each other.

The obtained first-stage foamed particles exhibited two melting points of 118° C. and 126° C. in differential scanning calorimetry and a DSC ratio of 30% and did not exhibit a shoulder peak. The Mz was 50×10⁴, the foaming ratio was 27 times, the surface layer film thickness was 10 μm, the average cell diameter was 320 μm, and the open-cell ratio was 4%.

[Production of Polyethylene-Based Resin in-Mold-Foam-Molded Body]

A polyethylene-based resin in-mold-foam-molded body was obtained in the same manner as in Example 1, except using the obtained first-stage foamed particles. The results are shown in Table 4.

TABLE 3-1

| | | | Example | | | | | |
|---|---|---|---|---|---|---|---|---|
| | | | 1 | 2 | 3 | 4 | 5 | 6 |
| Polyethylene-based resin | | — | A-2 | A-2 | A-2 | A-2 | A-2 | A-2 |
| Phosphorus-based | IRGAFOS168 | ppm | 450 | 1000 | 1000 | 1000 | 1000 | 750 |
| antioxidant | | | | | | | | |
| Phenol-based | IRGANOX1076 | ppm | 300 | 300 | 300 | 300 | | |
| antioxidant | IRGANOX1010 | ppm | | | | | 300 | 250 |
| Antioxidant ratio | | — | 1.5 | 3.3 | 3.3 | 3.3 | 3.3 | 3.0 |
| Total amount of antioxidant | | ppm | 750 | 1300 | 1300 | 1300 | 1300 | 1000 |
| Metal stearate | Calcium stearate | ppm | 400 | 400 | 400 | 400 | 400 | 400 |
| Inorganic substance | Talc | ppm | 300 | 300 | 300 | 300 | 300 | 1000 |
| Total amount of antioxidant + metal | | ppm | 1450 | 2000 | 2000 | 2000 | 2000 | 2400 |
| stearate + inorganic substance | | | | | | | | |
| Hydrophilic | Glycerin | ppm | 2000 | 2000 | 2000 | 2000 | 2000 | 2000 |
| compound | PEG (Molecular weight of 300) | ppm | | | | | | |
| | PEG (Molecular weight of 6000) | ppm | | | | | | |
| | Melamine | ppm | | | | | | |
| Polyethylene- | Resin particle number | — | P-1 | P-3 | P-4 | P-5 | P-6 | P-7 |
| based resin | Resin temperature in extrusion | ° C. | 210 | 210 | 290 | 290 | 290 | 290 |
| particles for | Discharge amount | kg/hr | 20 | 20 | 20 | 30 | 20 | 20 |
| foaming | Mz (×10⁻⁴)(Note) | — | 50 | 50 | 50 | 50 | 50 | 50 |
| First-stage foaming | Amount of carbon dioxide | Part by | 7.5 | 7.5 | 7.5 | 7.5 | 7.5 | 7.5 |
| conditions | | weight | | | | | | |
| | Isobutane | Part by | — | — | — | — | — | — |
| | | weight | | | | | | |
| | Foaming temperature | ° C. | 122 | 122 | 122 | 122 | 122 | 122 |
| | Foaming pressure (gauge pressure) | MPa | 3.4 | 3.4 | 3.4 | 3.4 | 3.4 | 3.4 |
| First-stage foamed | Melting peak temperature on | ° C. | 117 | 117 | 117 | 117 | 117 | 117 |
| particles | low-temperature side | | | | | | | |
| | Melting peak temperature on | ° C. | 128 | 128 | 128 | 128 | 128 | 128 |
| | high-temperature side | | | | | | | |
| | DSC ratio | % | 30 | 30 | 30 | 30 | 30 | 30 |
| | Mz (×10⁻⁴)(Note) | — | — | — | — | — | — | — |
| | Foaming ratio | Times | 11 | 11 | 11 | 11 | 11 | 9 |
| | Surface layer film thickness | μm | 30 | 29 | 29 | 29 | 29 | 23 |
| | Average cell diameter | μm | 130 | 120 | 120 | 120 | 120 | 110 |
| | Open-cell ratio | % | 2 | 2 | 2 | 2 | 2 | 2 |
| Second-stage foaming | Internal pressure of foamed | MPa | 0.57 | 0.57 | 0.57 | 0.57 | 0.57 | 0.57 |
| conditions | particles (absolute pressure) | | | | | | | |
| | Steam pressure (gauge pressure) | MPa | 0.06 | 0.06 | 0.06 | 0.06 | 0.06 | 0.06 |
| Second-stage foamed | Melting peak temperature on | ° C. | 118 | 118 | 118 | 118 | 118 | 118 |
| particles | low-temperature side | | | | | | | |
| | Melting peak temperature on | ° C. | 128 | 128 | 128 | 128 | 128 | 128 |
| | high-temperature side | | | | | | | |
| | DSC ratio | % | 40 | 40 | 40 | 40 | 40 | 40 |
| | Shoulder ratio | % | 0.3 | 0.3 | 0.3 | 0.3 | 0.3 | 0.3 |
| | Mz (×10⁻⁴)(Note) | — | 50 | 50 | 50 | 50 | 50 | 50 |
| | Foaming ratio | Times | 26 | 27 | 27 | 27 | 27 | 25 |
| | Surface layer film thickness | μm | 23 | 22 | 22 | 22 | 22 | 14 |
| | Average cell diameter | μm | 250 | 230 | 230 | 230 | 230 | 200 |
| | Open-cell ratio | % | 5 | 5 | 5 | 5 | 5 | 5 |
| In-mold-foam- | Minimum molding pressure | MPa | 0.11 | 0.11 | 0.11 | 0.11 | 0.11 | 0.11 |
| molded body | (Fusibility) | | | | | | | |
| | Yellowing | — | Δ | ◯ | ◯ | ◯ | ◯ | ◯ |
| | Surface beauty | — | ⊚ | ⊚ | ⊚ | ⊚ | ⊚ | ⊚ |
| | Pattern of molded body cut | — | ◯ | ◯ | ◯ | ◯ | ◯ | ◯ |
| | cross section | | | | | | | |
| | Remarks | — | — | — | — | — | — | — |

(Note):
In the column of Mz, values obtained by multiplying Mz by 10⁻⁴ are indicated.

TABLE 3-2

| | | | Example | | | | | |
|---|---|---|---|---|---|---|---|---|
| | | | 7 | 8 | 9 | 10 | 11 | 12 |
| Polyethylene-based resin | | — | A-1 | A-3 | A-2 | A-2 | A-1 | A-3 |
| Phosphorus-based | IRGAFOS168 | ppm | 1000 | 1000 | 1500 | 1000 | 1000 | 1500 |
| antioxidant | | | | | | | | |
| Phenol-based | IRGANOX1076 | ppm | 300 | 300 | 250 | 300 | 300 | 250 |
| antioxidant | IRGANOX1010 | ppm | | | | | | |
| Antioxidant ratio | | — | 3.3 | 3.3 | 6.0 | 3.3 | 3.3 | 6.0 |
| Total amount of antioxidant | | ppm | 1300 | 1300 | 1750 | 1300 | 1300 | 1750 |
| Metal stearate | Calcium stearate | ppm | 400 | 400 | 400 | 400 | 400 | 400 |
| Inorganic substance | Talc | ppm | 300 | 300 | 300 | 2000 | 300 | 300 |
| Total amount of antioxidant + metal | | ppm | 2000 | 2000 | 2450 | 3700 | 2000 | 2450 |
| stearate + inorganic substance | | | | | | | | |
| Hydrophilic | Glycerin | ppm | 2000 | 2000 | 2000 | 2000 | 2000 | 100 |
| compound | PEG (Molecular weight of 300) | ppm | | | | | | |
| | PEG (Molecular weight of 6000) | ppm | | | | | | |
| | Melamine | ppm | | | | | | |
| Polyethylene- | Resin particle number | — | — | — | — | — | — | — |
| based resin | Resin temperature in extrusion | ° C. | 210 | 210 | 210 | 210 | 210 | 210 |
| particles for | Discharge amount | kg/hr | 20 | 20 | 20 | 20 | 20 | 20 |
| foaming | Mz (×10⁻⁴)(Note) | — | 41 | 69 | 50 | 50 | 41 | 69 |
| First-stage foaming | Amount of carbon dioxide | Part by | 7.5 | 7.5 | 7.5 | 7.5 | 7.5 | 7.5 |
| conditions | | weight | | | | | | |
| | Isobutane | Part by | — | — | — | — | — | — |
| | | weight | | | | | | |
| | Foaming temperature | ° C. | 122 | 122 | 122 | 122 | 122 | 122 |
| | Foaming pressure (gauge pressure) | MPa | 3.4 | 3.4 | 3.4 | 3.4 | 3.4 | 3.4 |
| First-stage foamed | Melting peak temperature on | ° C. | 117 | 116 | 117 | 117 | 117 | 117 |
| particles | low-temperature side | | | | | | | |
| | Melting peak temperature on | ° C. | 128 | 128 | 128 | 128 | 128 | 128 |
| | high-temperature side | | | | | | | |
| | DSC ratio | % | 28 | 31 | 30 | 30 | 28 | 30 |
| | Mz (×10⁻⁴)(Note) | — | — | — | — | — | — | — |
| | Foaming ratio | Times | 10 | 9 | 11 | 12 | 10 | 7 |
| | Surface layer film thickness | μm | 28 | 29 | 27 | 17 | 28 | 16 |
| | Average cell diameter | μm | 130 | 110 | 110 | 100 | 130 | 90 |
| | Open-cell ratio | % | 4 | 2 | 2 | 2 | 4 | 2 |
| Second-stage foaming | Internal pressure of foamed | MPa | 0.57 | 0.57 | 0.57 | 0.57 | | 0.57 |
| conditions | particles (absolute pressure) | | | | | | | |
| | Steam pressure (gauge pressure) | MPa | 0.06 | 0.05 | 0.06 | 0.06 | | 0.06 |
| Second-stage foamed | Melting peak temperature on | ° C. | 118 | 117 | 118 | 118 | | 118 |
| particles | low-temperature side | | | | | | | |
| | Melting peak temperature on | ° C. | 128 | 128 | 128 | 128 | | 128 |
| | high-temperature side | | | | | | | |
| | DSC ratio | % | 39 | 41 | 40 | 40 | | 40 |
| | Shoulder ratio | % | 0.3 | 0.3 | 0.3 | 0.3 | | 0.3 |
| | Mz (×10⁻⁴)(Note) | — | 41 | 69 | 50 | 50 | | 69 |
| | Foaming ratio | Times | 28 | 27 | 27 | 29 | | 21 |
| | Surface layer film thickness | μm | 21 | 22 | 20 | 12 | | 12 |
| | Average cell diameter | μm | 300 | 230 | 210 | 200 | | 190 |
| | Open-cell ratio | % | 6 | 5 | 5 | 5 | | 4 |
| In-mold-foam- | Minimum molding pressure | MPa | 0.11 | 0.11 | 0.11 | 0.11 | 0.11 | 0.11 |
| molded body | (Fusibility) | | | | | | | |
| | Yellowing | — | ◯ | ◯ | ◯ | ◯ | ◯ | ◯ |
| | Surface beauty | — | ⊚ | ⊚ | ⊚ | ⊚ | Δ | ⊚ |
| | Pattern of molded body cut | — | ◯ | ◯ | ◯ | ◯ | ◯ | ◯ |
| | cross section | | | | | | | |
| | Remarks | — | — | — | — | — | — | — |

(Note):
In the column of Mz, values obtained by multiplying Mz by 10⁻⁴ are indicated.

TABLE 3-3

| | | | Example | | | | | | | |
|---|---|---|---|---|---|---|---|---|---|---|
| | | | 13 | 14 | 15 | 16 | 17 | 18 | 19 | 20 |
| Polyethylene-based resin | | — | A-2 | A-2 | A-2 | A-2 | A-2 | B-2 | B-1 | A-2 |
| Phosphorus-based | IRGAFOS168 | ppm | 1500 | 1500 | 1500 | 1000 | 450 | 1000 | 1000 | 1000 |
| antioxidant | | | | | | | | | | |
| Phenol-based | IRGANOX1076 | ppm | 250 | 250 | 250 | 300 | 300 | 300 | 300 | 300 |
| antioxidant | IRGANOX1010 | ppm | | | | | | | | |
| Antioxidant ratio | | — | 6.0 | 6.0 | 6.0 | 3.3 | 1.5 | 3.3 | 3.3 | 3.3 |
| Total amount of antioxidant | | ppm | 1750 | 1750 | 1750 | 1300 | 750 | 1300 | 1300 | 1300 |
| Metal stearate | Calcium stearate | ppm | 400 | 400 | 400 | 400 | 400 | 400 | 400 | 200 |
| Inorganic substance | Talc | ppm | 300 | 300 | 300 | 100 | 300 | 300 | 300 | 300 |
| Total amount of antioxidant + metal | | ppm | 2450 | 2450 | 2450 | 1800 | 1450 | 2000 | 2000 | 1800 |
| stearate + inorganic substance | | | | | | | | | | |
| Hydrophilic | Glycerin | ppm | | | | 2000 | 2000 | 2000 | | 2000 |
| compound | PEG (Molecular weight of 300) | ppm | 5000 | | | | | | | |
| | PEG (Molecular weight of 6000) | ppm | | 5000 | | | | | 5000 | |
| | Melamine | ppm | | | 20000 | | | | | |
| Polyethylene- | Resin particle number | — | — | — | — | — | P-2 | P-8 | — | — |
| based resin | Resin temperature in extrusion | ° C. | 210 | 210 | 210 | 290 | 290 | 210 | 210 | 290 |
| particles for | Discharge amount | kg/hr | 20 | 20 | 20 | 20 | 20 | 20 | 20 | 20 |
| foaming | Mz (×10⁻⁴)(Note) | — | 50 | 50 | 50 | 50 | 51 | 78 | 36 | 50 |
| First-stage foaming | Amount of carbon dioxide | Part by | 7.5 | 7.5 | 7.5 | 7.5 | 7.5 | 7.5 | 7.5 | 7.5 |
| conditions | | weight | | | | | | | | |
| | Isobutane | Part by | — | — | — | — | — | — | — | — |
| | | weight | | | | | | | | |
| | Foaming temperature | ° C. | 122 | 122 | 122 | 122 | 122 | 122 | 122 | 122 |
| | Foaming pressure (gauge pressure) | MPa | 3.4 | 3.4 | 3.4 | 3.4 | 3.4 | 3.4 | 3.4 | 3.4 |
| First-stage foamed | Melting peak temperature on | ° C. | 117 | 117 | 117 | 117 | 117 | 117 | 117 | 117 |
| particles | low-temperature side | | | | | | | | | |
| | Melting peak temperature on | ° C. | 128 | 128 | 128 | 128 | 128 | 128 | 128 | 128 |
| | high-temperature side | | | | | | | | | |
| | DSC ratio | % | 30 | 30 | 30 | 30 | 30 | 30 | 29 | 30 |
| | Mz (×10⁻⁴)(Note) | — | — | — | — | — | — | — | — | — |
| | Foaming ratio | Times | 11 | 10 | 10 | 9 | 7 | 6 | 9 | 10 |
| | Surface layer film thickness | μm | 27 | 27 | 20 | 100 | 23 | 25 | 24 | 31 |
| | Average cell diameter | μm | 110 | 110 | 80 | 180 | 80 | 90 | 120 | 130 |
| | Open-cell ratio | % | 2 | 2 | 2 | 2 | 2 | 2 | 7 | 2 |
| Second-stage foaming | Internal pressure of foamed | MPa | 0.57 | 0.57 | 0.57 | 0.57 | 0.57 | 0.57 | 0.57 | 0.57 |
| conditions | particles (absolute pressure) | | | | | | | | | |
| | Steam pressure (gauge pressure) | MPa | 0.06 | 0.06 | 0.06 | 0.06 | 0.06 | 0.06 | 0.06 | 0.06 |
| Second-stage foamed | Melting peak temperature on | ° C. | 118 | 118 | 118 | 118 | 118 | 118 | 118 | 118 |
| particles | low-temperature side | | | | | | | | | |
| | Melting peak temperature on | ° C. | 128 | 128 | 128 | 128 | 128 | 128 | 128 | 128 |
| | high-temperature side | | | | | | | | | |
| | DSC ratio | % | 40 | 40 | 40 | 40 | 40 | 40 | 39 | 40 |
| | Shoulder ratio | % | 0.3 | 0.3 | 0.3 | 0.3 | 0.3 | 0.3 | 0.3 | 0.3 |
| | Mz (×10⁻⁴)(Note) | — | 50 | 50 | 50 | 50 | 51 | 78 | 36 | 50 |
| | Foaming ratio | Times | 27 | 25 | 25 | 25 | 14 | 18 | 21 | 26 |
| | Surface layer film thickness | μm | 20 | 20 | 11 | 65 | 11 | 11 | 11 | 23 |
| | Average cell diameter | μm | 210 | 200 | 200 | 400 | 140 | 170 | 240 | 320 |
| | Open-cell ratio | % | 5 | 4 | 4 | 3 | 5 | 5 | 10 | 5 |
| In-mold-foam- | Minimum molding pressure | MPa | 0.11 | 0.11 | 0.11 | 0.11 | 0.11 | 0.12 | 0.11 | 0.11 |
| molded body | (Fusibility) | | | | | | | | | |
| | Yellowing | — | ◯ | ◯ | ◯ | ◯ | Δ | ◯ | ◯ | ◯ |
| | Surface beauty | — | ⊚ | ⊚ | ◯ | ⊚ | ◯ | ◯ | ⊚ | ⊚ |
| | Pattern of molded body cut | — | ◯ | ◯ | ◯ | ◯ | ◯ | ◯ | ◯ | ◯ |
| | cross section | | | | | | | | | |
| | Remarks | — | — | — | — | — | — | — | Slight | — |
| | | | | | | | | | shrinkage | |

(Note):
In the column of Mz, values obtained by multiplying Mz by 10⁻⁴ are indicated.

TABLE 4

| | | | Comparative Example | | | | | |
|---|---|---|---|---|---|---|---|---|
| | | | 1 | 2 | 3 | 4 | 5 | 6 |
| Polyethylene-based resin | | — | B-3 | B-4 | A-2 | A-2 | A-2 | A-2 |
| Phosphorus-based | IRGAFOS168 | ppm | 1000 | 1000 | 100 | 2400 | 1000 | 1000 |
| antioxidant | | | | | | | | |
| Phenol-based | IRGANOX1076 | ppm | 300 | 300 | 300 | 300 | 300 | 300 |
| antioxidant | IRGANOX1010 | ppm | | | | | | |
| Antioxidant ratio | | — | 3.3 | 3.3 | 0.33 | 8.0 | 3.3 | 3.3 |
| Total amount of antioxidant | | ppm | 1300 | 1300 | 400 | 2700 | 1300 | 1300 |
| Metal stearate | Calcium stearate | ppm | 400 | 400 | 400 | 400 | 400 | 400 |
| Inorganic substance | Talc | ppm | 300 | 300 | 100 | 1000 | 300 | 300 |
| Total amount of | | ppm | 2000 | 2000 | 900 | 4100 | 2000 | 2000 |
| antioxidant + metal stearate + inorganic substance | | | | | | | | |
| Hydrophilic | Glycerin | ppm | 2000 | 2000 | 40 | 2000 | 25000 | |
| compound | PEG (Molecular weight of 300) | ppm | | | | | | |
| | PEG (Molecular weight of 6000) | ppm | | | | | | |
| | Melamine | ppm | | | | | | |
| Polyethylene- | Resin particle number | — | — | — | — | — | — | — |
| based resin | Resin temperature in extrusion | ° C. | 210 | 210 | 210 | 210 | No stable | 210 |
| particles for | Discharge amount | kg/hr | 20 | 20 | 20 | 20 | extrusion due to | 20 |
| foaming | Mz (×10⁻⁴)(Note) | | 28 | 105 | 50 | 50 | strand cutting | 50 |
| First-stage foaming | Amount of carbon dioxide | Part by | 7.5 | 7.5 | 7.5 | 7.5 | | — |
| conditions | | weight | | | | | | |
| | Isobutane | Part by | — | — | — | — | | 19 |
| | | weight | | | | | | |
| | Foaming temperature | ° C. | 122 | 122 | 122 | 122 | | 114 |
| | Foaming pressure (gauge pressure) | MPa | 3.4 | 3.4 | 3.4 | 3.4 | | 1.8 |
| First-stage foamed | Melting peak temperature on | ° C. | 117 | 117 | 117 | 117 | | 118 |
| particles | low temperature side | | | | | | | |
| | Melting peak temperature on | ° C. | 128 | 125 | 128 | 128 | | 126 |
| | high-temperature side | | | | | | | |
| | DSC ratio | % | 28 | 30 | 28 | 30 | | 30 |
| | Mz (×10⁻⁴)(Note) | — | — | — | — | — | | 50 |
| | Foaming ratio | Times | 7 | 4 | 6 | 12 | | 27 |
| | Surface layer film thickness | μm | 24 | 45 | 17 | 20 | | 10 |
| | Average cell diameter | μm | 150 | 70 | 140 | 80 | | 320 |
| | Open-cell ratio | % | 15 | 2 | 2 | 2 | | 4 |
| Second-stage foaming | Internal pressure of foamed | MPa | 0.57 | 0.57 | 0.57 | 0.57 | | — |
| conditions | particles (absolute pressure) | | | | | | | |
| | Steam pressure (gauge pressure) | MPa | 0.06 | 0.06 | 0.06 | 0.06 | | — |
| Second-stage foamed | Melting peak temperature on | ° C. | 118 | 117 | 118 | 118 | | — |
| particles | low temperature side | | | | | | | |
| | Melting peak temperature on | ° C. | 128 | 125 | 128 | 128 | | — |
| | high-temperature side | | | | | | | |
| | DSC ratio | % | 39 | 40 | 39 | 40 | | — |
| | Shoulder ratio | % | 0.3 | 0.3 | 0.3 | 0.3 | | — |
| | Mz (×10⁻⁴)(Note) | — | 28 | 105 | 50 | 50 | | — |
| | Foaming ratio | Times | 15 | 16 | 19 | 27 | | — |
| | Surface layer film thickness | μm | 9 | 20 | 8 | 9 | | — |
| | Average cell diameter | μm | 270 | 140 | 290 | 150 | | — |
| | Open-cell ratio | % | 20 | 5 | 5 | 5 | | — |
| In-mold-foam- | Minimum molding pressure | MPa | 0.11 | 0.12 | 0.11 | 0.11 | | 0.11 |
| molded body | (Fusibility) | | | | | | | |
| | Yellowing | — | ◯ | ◯ | X | ◯ | | ◯ |
| | Surface beauty | — | Δ | X | Δ | Δ | | X |
| | Pattern of molded body cut | — | X | ◯ | X | X | | X |
| | cross section | | | | | | | |
| | Remarks | — | Noticeable | — | — | — | | — |
| | | | shrinkage | | | | | |

(Note):
In the column of Mz, values obtained by multiplying Mz by 10⁻⁴ are indicated.

A comparison between Examples 2, 7, 8, 18, and 19 and Comparative Examples 1 and 2 shows that, even when the total content of the antioxidant, the metal stearate, and the inorganic substance is 2000 ppm in the case where the Mz of the polyethylene-based resin foamed particles is in the range from 30×10⁴ or more to 100×10⁴ or less, the surface layer film thickness is 11 μm or more and the surface beauty of the polyethylene-based resin in-mold-foam-molded body to be obtained is favorable.

When the Mz of the polyethylene-based resin foamed particles exceeds 100×10⁴, the surface layer film thickness is 11 μm or more but the influence of a high-molecular-weight component in the polyethylene-based resin is high, so that the surface beauty of the polyethylene-based resin in-mold-foam-molded body to be obtained decreases. Contrarily, when the Mz is less than 30×10⁴, the open-cell ratio of the polyethylene-based resin foamed particles is high and shrinkage of the polyethylene-based resin in-mold-foam-molded body to be obtained is noticeable.

A comparison between Example 10 and Comparative Example 4 shows that, when the total content of the antioxidant, the metal stearate, and the inorganic substance exceeds 4000 ppm, the average cell diameter decreases even when the Mz of the polyethylene-based resin foamed particles is 50×10⁴, and the surface beauty of the polyethylene-based resin in-mold-foam-molded body decreases.

A comparison between Example 2 and Examples 3 and 4 shows that the present invention can obtain favorable polyethylene-based resin foamed particles and polyethylene-based resin in-mold-foam-molded body which are free from resin degradation even when the polyethylene-based resin particles for foaming are obtained at a high resin temperature of 290° C.

A comparison between Example 1 and Example 2 shows that, when the content of the phosphorus-based antioxidant is less than 500 ppm or when the antioxidant ratio is less than 2, yellowing of the surface of the polyethylene-based resin in-mold-foam-molded body cannot be sufficiently suppressed.

The present invention is not limited to the embodiments described above and can be altered within the scope of Claims. An embodiment based on an appropriate combination of technical means disclosed in different embodiments is also included in the technical scope of the present invention.

### INDUSTRIAL APPLICABILITY

According to the polyethylene-based resin foamed particles and the production method thereof of the present invention, polyethylene-based resin foamed particles which are obtained by foaming polyethylene-based resin particles for foaming which have good productivity and achieve an increase in foaming ratio and in which the surface layer film thickness is large and resin degradation is reduced can be provided. Moreover, according to the polyethylene-based resin in-mold-foam-molded body of the present invention, a foam-molded body which has favorable surface beauty (surface smoothness) and also is suppressed in yellowing is obtained.

Therefore, the polyethylene-based resin foamed particles according to the present invention can be widely utilized in various industries as polyethylene-based resin foamed particles for use in shock absorbing materials, shock absorbing packaging materials, reusable shipping cartons, thermal insulating materials, and the like, for example.

1. Polyethylene-based resin foamed particles comprising, as a base resin,
a polyethylene-based resin composition containing:
1000 ppm or more and 4000 ppm or less in total of one or more compounds selected from the group consisting of an antioxidant, metal stearate, and an inorganic substance; and
50 ppm or more and 20000 ppm or less of a hydrophilic compound, wherein
a Z average molecular weight is 30×10⁴ or more and 100×10⁴ or less, a surface layer film thickness is 11 μm or more and 120 μm or less, and an open-cell ratio is 12% or less.

2. The polyethylene-based resin foamed particles according to claim 1, wherein the Z average molecular weight is 40×10⁴ or more and 80×10⁴ or less.

3. The polyethylene-based resin foamed particles according to claim 1, wherein the Z average molecular weight is 40×10⁴ or more and 70×10⁴ or less.

4. The polyethylene-based resin foamed particles according to claim 1, wherein the hydrophilic compound is glycerin and/or polyethylene glycol.

5. The polyethylene-based resin foamed particles according to claim 1, wherein the surface layer film thickness of the polyethylene-based resin foamed particles is 11 μm or more and 100 μm or less.

6. The polyethylene-based resin foamed particles according to claim 1, wherein the surface layer film thickness of the polyethylene-based resin foamed particles is 12 μm or more and 80 μm or less.

7. The polyethylene-based resin foamed particles according to claim 1, wherein a foaming ratio of the polyethylene-based resin foamed particles is 5 times or more and 45 times or less.

8. The polyethylene-based resin foamed particles according to claim 1, wherein a total content of one or more compounds selected from the group consisting of an antioxidant, metal stearate, and an inorganic substance is 1600 ppm or more and 3700 ppm or less.

9. The polyethylene-based resin foamed particles according to claim 1, wherein an average cell diameter of the polyethylene-based resin foamed particles is 180 μm or more and 450 μm or less.

10. The polyethylene-based resin foamed particles according to claim 1, wherein
the antioxidant in the polyethylene-based resin composition includes a phosphorus-based antioxidant and a phenol-based antioxidant, and
satisfies (a1) and (a2) conditions described below:
(a1) a content of the phosphorus-based antioxidant contained in the polyethylene-based resin composition is 500 ppm or more and 1500 ppm or less; and
(a2) a ratio of a content of the phosphorus-based antioxidant to a content of the phenol-based antioxidant (content of phosphorus-based antioxidant/content of phenol-based antioxidant) contained in the polyethylene-based resin composition is 2.0 or more and 7.5 or less.

11. The polyethylene-based resin foamed particles according to claim 10, wherein the ratio of the content of the phosphorus-based antioxidant to the content of the phenol-based antioxidant is 2.5 or more and 5.0 or less.

12. The polyethylene-based resin foamed particles according to claim 1, wherein a total content of the phosphorus-based antioxidant and the phenol-based antioxidant contained in the polyethylene-based resin composition is 800 ppm or more and 1900 ppm or less.

13. The polyethylene-based resin foamed particles according to claim 1, wherein the polyethylene-based resin composition contains metal stearate and a content of the metal stearate contained in the polyethylene-based resin composition is 200 ppm or more and 700 ppm or less.

14. The polyethylene-based resin foamed particles according to claim 1, wherein the polyethylene-based resin composition contains an inorganic substance and a content of the inorganic substance contained in the polyethylene-based resin composition is 100 ppm or more and 2500 ppm or less.

15. The polyethylene-based resin foamed particles according to claim 1, wherein the average cell diameter is 200 μm or more and 400 μm or less.

16. The polyethylene-based resin foamed particles according to claim 1, wherein the polyethylene-based resin at least contains a linear low density polyethylene-based resin.

17. A polyethylene-based resin in-mold-foam-molded body, which is obtained by in-mold foam molding the polyethylene-based resin foamed particles according to claim 1.

18. A method for producing polyethylene-based resin foamed particles having a Z average molecular weight of 30×10⁴ or more and 100×10⁴ or less, a surface layer film thickness of 11 μm or more and 120 μm or less, and an open-cell ratio of 12% or less,
the method comprising a first-stage foaming process described below:
first-stage foaming process of dispersing polyethylene-based resin particles for foaming containing a polyethylene-based resin composition containing 1000 ppm or more and 4000 ppm or less in total of one or more compounds selected from the group consisting of an antioxidant, metal stearate, and an inorganic substance and 50 ppm or more and 20000 ppm or less of a hydrophilic compound together with a foaming agent in an aqueous dispersion medium in an airtight container, heating the resultant polyethylene-based resin particles for foaming to a temperature equal to or higher than a softening point of the polyethylene-based resin particles for foaming, pressurizing the resultant polyethylene-based resin particles for foaming, and then releasing the resultant polyethylene-based resin particles for foaming to a pressure zone in which a pressure is lower than an internal pressure of the airtight container to thereby produce polyethylene-based resin foamed particles.

19. A method for producing polyethylene-based resin foamed particles having a Z average molecular weight of 30×10⁴ or more and 100×10⁴ or less, a portion with a surface layer film thickness of 11 μm or more and 120 μm or less, and an open-cell ratio of 12% or less,
the method comprising a first-stage foaming process and a second-stage foaming process described below:
first-stage foaming process of dispersing polyethylene-based resin particles for foaming containing a polyethylene-based resin composition containing 1000 ppm or more and 4000 ppm or less in total of one or more compounds selected from the group consisting of an antioxidant, metal stearate, and an inorganic substance and 50 ppm or more and 20000 ppm or less of a hydrophilic compound together with carbon dioxide in an aqueous dispersion medium in an airtight container, heating the resultant polyethylene-based resin particles for foaming to a temperature equal to or higher than a softening point of the polyethylene-based resin particles for foaming, pressurizing the resultant polyethylene-based resin particles for foaming, and then releasing the resultant polyethylene-based resin particles for foaming to a pressure zone in which a pressure is lower than an internal pressure of the airtight container to thereby produce polyethylene-based resin foamed particles; and
second-stage foaming process of placing the polyethylene-based resin foamed particles obtained in the first-stage foaming process into a pressure resistant container, impregnating the polyethylene-based resin foamed particles with inorganic gas containing at least one kind of gas selected from the group consisting of air, nitrogen, and carbon dioxide to give internal pressure, and then heating the polyethylene-based resin foamed particles for further foaming.

20. The method for producing polyethylene-based resin foamed particles according to claim 18, wherein
the antioxidant in the polyethylene-based resin composition includes a phosphorus-based antioxidant and a phenol-based antioxidant, and
satisfies (a1) and (a2) conditions described below:
(a1) a content of the phosphorus-based antioxidant contained in the polyethylene-based resin composition is 500 ppm or more and 1500 ppm or less; and
(a2) a ratio of a content of the phosphorus-based antioxidant to a content of the phenol-based antioxidant (content of phosphorus-based antioxidant/content of phenol-based antioxidant) contained in the polyethylene-based resin composition is 2.0 or more and 7.5 or less.

21. The method for producing polyethylene-based resin foamed particles according to claim 18, wherein the polyethylene-based resin particles for foaming are obtained by being melt and kneaded by an extruder in a resin temperature range from 250° C. or higher to 320° C. or less.
